(19) United States
(12) Patent Application Publication
(10) Pub. No.: US 2026/0236697 A1
(43) Pub. Date: Aug. 13, 2026

(54) Systems and Methods for Offline Generative Adaptation in Persistent Cognitive Machines

(71) Applicant: AtomBeam Technologies Inc., Moraga, CA (US)

(72) Inventors: Brian Galvin, Silverdale, WA (US); Alexandria Tucker, Urbana, IL (US); Anton Swifton, Seattle, WA (US); Alan McCord, Forney, TX (US)

(21) Appl. No.: 19/533,094

(22) Filed: Feb. 6, 2026

Related U.S. Application Data
(63) Continuation-in-part of application No. 19/397,858, filed on Nov. 21, 2025.
Application No. 19/397,858 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/900,388, filed on Oct. 16, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for offline adaptation in persistent cognitive systems using a dedicated dreamspace manifold that operates separately from online cognitive processes. During periods when the system is not engaged in real-time cognition, an offline adaptation engine explores the dreamspace manifold through stochastic evolution processes driven by drift and noise components. The engine generates counterfactual trajectories that deviate from stored experiential paths and synthesizes new candidate structures through recombination and generative operations. A projection interface evaluates these candidates for geometric consistency and projects admissible structures into a candidate set for evaluation when the system returns to online operation, without directly modifying persistent memory. An isolation controller ensures that online cognitive manifolds remain unchanged during offline operations, maintaining system stability while enabling exploratory expansion of representational capacity.

### CROSS-REFERENCE TO RELATED APPLICATIONS

Priority is claimed in the application data sheet to the following patents or patent applications, each of which is expressly incorporated herein by reference in its entirety:
Ser. No. 19/397,858
63/900,388
Ser. No. 19/328,094
Ser. No. 19/321,173
Ser. No. 19/284,115
Ser. No. 19/051,193
63/847,082
63/847,091
63/847,096
63/847,101

### BACKGROUND OF THE INVENTION

### Field of the Art

The present invention relates to the field of artificial intelligence and computational geometry, and more specifically to systems and methods for offline generative evolution of cognitive manifolds through stochastic, perturbative, and counterfactual dreaming processes.

### Discussion of the State of the Art

Contemporary artificial intelligence architectures-including large language models, multimodal inference engines, and memory-augmented reasoning systems-exhibit increasingly sophisticated capabilities in representing, retrieving, and transforming information. Recent advances have produced systems capable of maintaining persistent cognitive manifolds, modeling experiential structure as geometric entities, and enforcing stability across evolving representational spaces. Such systems operate primarily through online computation, where cognitive flows, memory compression mechanisms, and metacognitive corrections act in real time to maintain coherent behavior. These online processes shape and refine representational geometry but remain fundamentally constrained by the experiential histories and structural regularities encoded during active operation.

Despite these advances, existing systems lack any principled mechanism for offline generative expansion of representational capacity. Current architectures do not perform exploratory or perturbative evolution of cognitive geometry outside of active inference cycles. They are unable to generate counterfactual trajectories that depart from stored experience, cannot construct speculative or hypothetical manifold structures, and do not incorporate stochastic or topological experimentation as part of their representational dynamics. More importantly, the state of the art provides no formal substrate for safely conducting such exploration without interfering with online reasoning, memory stability, or cognitive identity. As a result, persistent cognitive systems remain bounded by the trajectories and structures that arise during normal operation and cannot discover latent conceptual patterns or expand their manifolds beyond accumulated experience.

Existing AI frameworks also lack structured mechanisms for recombining manifold entities into novel geometric constructs, applying annealing or cooling processes to refine emergent representations, or performing controlled curvature or topological modifications to investigate hypothetical extensions of representational space. Systems further fail to coordinate such exploratory operations across multiple cognitive instances, leaving no pathway for federated generation of shared hypotheses or cross-agent speculative structures.

What is needed is a system and method that introduce a mathematically defined offline dreaming engine capable of performing stochastic, perturbative, and generative evolution of a dedicated dreamspace manifold; generating counterfactual trajectories and novel latent structures; applying exploratory annealing and topological variation; and doing so in complete isolation from online cognitive manifolds while producing candidate structures for later evaluation.

### SUMMARY OF THE INVENTION

Accordingly, the inventor has conceived and reduced to practice a computer-implemented dreaming and offline adaptation engine that operates on a dedicated geometric manifold to explore hypothetical cognitive structures, synthesize counterfactual trajectories, and generate candidate representational constructs while maintaining complete isolation from online cognitive processes. The invention introduces a dreamspace manifold that is distinct from online manifolds and supports stochastic, perturbative, and generative evolution during offline periods. An offline adaptation engine drives manifold evolution through stochastic flows, produces counterfactual geometric trajectories, and synthesizes new latent structures, while a projection interface evaluates and transfers admissible candidates for later online consideration. An isolation controller ensures that all such operations occur exclusively during offline operation without modifying or influencing active cognitive manifolds.

In an embodiment, a computer system is configured to implement a dreamspace manifold that represents cognitive or experiential structures as geometric entities in a multidimensional space, the dreamspace manifold being separate from online cognitive manifolds and defined by a metric governing its geometric relationships. The system implements an offline adaptation engine that operates only during offline periods to evolve states within the dreamspace via stochastic manifold-evolution processes including drift and noise components, to generate counterfactual trajectories that diverge from stored experiential or cognitive paths, and to synthesize candidate geometric structures through recombination or generative operations acting on entities within the dreamspace. The system further implements a projection interface that evaluates dream-generated structures for geometric admissibility and projects admissible structures into a candidate set for later evaluation when online operation resumes, without modifying persistent memory during dreaming. The system also includes an isolation controller that prevents modification of online cognitive manifolds while the offline adaptation engine is active.

In an aspect of an embodiment, the drift component of the dreaming evolution arises from an exploration potential that biases motion toward regions of the dreamspace corresponding to lower visitation density in online operation, thereby emphasizing exploration of rarely encountered or previously unvisited representational states.

In an aspect of an embodiment, the noise component includes a state-dependent noise tensor that incorporates local curvature information derived from the dreamspace metric so that stochastic perturbations reflect intrinsic geometric structure.

In an aspect of an embodiment, the generation of counterfactual trajectories includes perturbing geodesic paths that emanate from points along stored cognitive or experiential trajectories, or inverting drift fields associated with online cognitive dynamics, or performing both operations to induce divergent hypothetical paths.

In an aspect of an embodiment, the recombination or generative operations include geometric blending of manifold structures along geodesic paths that connect the structures within the dreamspace so that hybrid or interpolated constructs are produced through manifold-aware combinations.

In an aspect of an embodiment, the offline adaptation engine applies annealing dynamics to candidate structures, including stochastic perturbation with a noise amplitude that decreases according to a cooling schedule over a dreaming interval, thereby generating refined structures or emergent attractor configurations within the dreamspace.

In an aspect of an embodiment, the offline adaptation engine applies topological perturbation operations to the dreamspace, the operations being restricted to offline periods and involving controlled modifications to the manifold topology that expand representational capacity.

In an aspect of an embodiment, the offline adaptation engine evolves the dreamspace metric through curvature-inflation processes that increase local curvature in selected regions, the curvature-inflation being distinct from curvature-smoothing processes employed during online cognitive operation.

In an aspect of an embodiment, the computer system participates as one instance among multiple cognitive systems and coordinates dreaming operations across the systems through a federated dreaming process that couples stochastic exploration across their respective dreamspace manifolds and enables synthesis of cross-instance hypothetical structures.

The method embodiments corresponding to the foregoing system embodiments follow in an analogous manner and are not separately restated here.

### BRIEF DESCRIPTION OF THE DRAWING FIGURES

FIG. 1 illustrates an exemplary system architecture of a dreaming and offline adaptation engine comprising four functional layers operating on a dedicated dreamspace manifold.

FIG. 2 illustrates a dreamspace foundation layer configured to initialize geometric structures, compute exploration potentials, and generate state-dependent noise tensors for offline manifold evolution.

FIG. 3 illustrates a generative dynamics layer that performs stochastic manifold evolution and counterfactual trajectory generation using drift, noise, and deviation metrics.

FIG. 4 illustrates a synthesis and perturbation layer that applies geometric recombination, annealing dynamics, and topological modifications to candidate structures in the dreamspace manifold.

FIG. 5 illustrates an interface and coordination layer that evaluates dream-generated structures, enforces offline isolation, and manages projection and buffering of admissible candidates.

FIG. 6 illustrates an offline dreaming cycle including system idle detection, geometric initialization, stochastic exploration, candidate generation, and release of projected outputs.

FIG. 7 illustrates stochastic manifold evolution performed by a dreaming flow engine using exploration-guided drift, curvature-informed noise, and manifold-adapted integration.

FIG. 8 illustrates counterfactual trajectory generation using perturbed geodesic shooting, drift inversion, geodesic deviation, and hypothesis-driven latent flows.

FIG. 9 illustrates recombination and generative synthesis operations including geometric blending, latent interpolation, trajectory fusion, and fiberwise bundle recombination.

FIG. 10 illustrates annealing and cooling dynamics that refine candidate structures through temperature-scheduled stochastic flows and identify attractor configurations.

FIG. 11 illustrates output evaluation and projection, including admissibility filtering, manifold projection, and release of admissible structures to a transient candidate buffer.

FIG. 12 illustrates federated dreaming coordination across multiple cognitive system instances including product manifold construction, coupled stochastic flows, cross-agent synthesis, and per-instance candidate projection.

FIG. 13 illustrates an exemplary computing environment on which an embodiment described herein may be implemented.

### DETAILED DESCRIPTION OF THE INVENTION

The inventor has conceived and reduced to practice a system and method for generating, evolving, and refining cognitive and experiential representations through an offline dreaming architecture that operates on a dedicated geometric manifold isolated from online cognitive processes. The invention introduces a dreamspace manifold that supports stochastic evolution, perturbative geodesic deviation, counterfactual trajectory formation, geometric recombination, annealing-based refinement, and controlled topological variation, all executed exclusively during offline periods in which online cognitive manifolds remain invariant. The system employs a stochastic manifold-evolution engine to explore hypothetical states beyond accumulated experiential structure, synthesizes new latent constructs through manifold-aware blending and interpolation, and applies dynamic refinement procedures to reveal emergent prototypes and attractor configurations. A projection and admissibility interface evaluates the resulting geometric entities and prepares admissible constructs for later consideration when online operation resumes, while an isolation mechanism ensures that no speculative or generative structure produced during dreaming alters persistent memory or active cognitive geometry. The architecture further supports federated dreaming across multiple cognitive systems, enabling coordinated exploration and synthesis of shared hypothetical representations without compromising autonomy or online stability.

A computing system is configured to implement a dreaming and offline adaptation engine that operates on a dedicated geometric manifold during periods in which online cognitive processes are inactive. This engine enables generative, stochastic, and counterfactual evolution of cognitive and experiential representations while maintaining complete isolation from online cognitive manifolds and persistent memory. The system implements a dreamspace manifold that serves as an exploratory geometric substrate distinct from any manifold used during online reasoning. This dreamspace is constructed as a differentiable manifold equipped with a metric that defines distances, curvature, and neighborhood structure, and its geometry is configured to support perturbative and topologically flexible evolution.

The system initiates an offline adaptation engine when online cognitive activity has ceased. During such periods, states within the dreamspace manifold evolve through stochastic differential flows. A representative evolution equation is dX(t)=f_dream(X(t)) dt+Σ_dream(X(t)) dW_t, where f_dream is a drift component and Σ_dream is a noise tensor. The drift component incorporates an exploratory force that directs trajectories toward underrepresented regions of experiential space. An example formulation uses an exploration potential V_explore(x)=−log(ρ(x)+ε), where ρ(x) represents a density derived from experiential data and ε is a small offset value. The offline adaptation engine evaluates a gradient of this potential and generates motion consistent with f_dream(x)=−∇V_explore(x)+ξ(x), where ξ(x) introduces structured deviation from purely potential-driven flow. The noise tensor Σ_dream is defined over tangent spaces of the dreamspace manifold and is constructed to reflect geometric curvature, producing anisotropic dispersion patterns consistent with the underlying metric.

The offline adaptation engine generates counterfactual trajectories representing hypothetical evolutions not derived from stored experience. A counterfactual trajectory γ_e(t) may be produced by perturbing geodesics emanating from points along known experiential trajectories. A non-limiting expression for such perturbation is γ_e(t)=exp_{γ(t)}(ε v(t)), where v(t) is a tangent vector selected according to a distribution shaped by the noise tensor. Counterfactual exploration also occurs through drift inversion, in which a trajectory evolves according to \dot{γ}_e(t)=−f_real(γ(t))+δ(t), where f_real is an online drift field and δ(t) introduces bounded perturbation. Deviation from known trajectories can be characterized using a geodesic deviation field J(t) governed by a relation such as D²J/dt²=R_dream(\dot{γ}_e, J)\dot{γ}_e+Ξ(t), where R_dream is a curvature tensor of the dreamspace and Ξ(t) is a noise term. These constructions provide explicit mechanisms through which offline computation expands representational geometry beyond the boundaries defined by real cognitive trajectories.

The system synthesizes new representational structures through geometric recombination operations applied to entities embedded within the dreamspace manifold. Such operations include geometric blending of two structures using an interpolation T_new=exp_{T1}(λ log_{T1}(T2)), where λ is an interpolation parameter. Latent-manifold interpolation extends this construction to generate extrapolated structures using relations such as I_α(x, y)=exp_x(α log_x(y)), where α can extend beyond the interval [0,1]. Trajectories are recombined through a weighted logarithmic interpolation γ_comb(t)=exp_{γ1(t)}(θ(t) log_{γ1(t)}γ2(t)), where θ(t) varies over time. Narrative structures and fiber-decomposed experiential constructs are synthesized by applying these interpolation and blending operations to their respective geometric and semantic components. These generative processes allow the system to produce latent structures that are not present within any online manifold and that can serve as prototypes for future cognitive patterns.

A refinement stage is implemented through annealing dynamics operating within the dreamspace manifold. A representative annealing process evolves a structure T(t) according to dT/dt=−∇V_dream(T)+σ(t) η(t), where V_dream is a potential reflecting narrative, experiential, or conceptual affinities, η(t) is a stochastic term, and σ(t) decreases over time according to a cooling schedule such as σ(t)=σ₀ e\dot{γ}{−α t}. Early phases allow broad exploratory movement, while later phases encourage convergence toward stable attractor-like constructs. These attractor configurations represent refined or generalized structures derived from raw generative outputs and may reveal latent semantic relationships embedded within the dreamspace.

The system also performs structural and topological perturbations during offline operation. The dreamspace manifold accommodates surgical alterations, including excision and attachment of manifold segments. A region may undergo a handle-attachment process or exhibit creation, inflation, or collapse of topological holes. A non-limiting expression for hole evolution is ∂φ/∂t=ξ₁(x, t)−ξ₂(x, t) φ(x, t), where φ denotes a radius-like quantity associated with a topological feature. Branching structures can be generated by locally duplicating manifold sheets, for example using a construction such as Mdream∪exp_W(ε Z), where W is a region and Z is a normal field. Curvature characteristics of the manifold evolve according to geometric flows such as ∂g_dream/∂t=α g_dream+Γ(x, t), where α is a positive scalar and Γ introduces curvature perturbations. In some implementations, discrete graph-embedded regions undergo connectivity modification based on a compatibility function Θ that governs addition or removal of edges. These operations collectively expand the structural hypothesis space accessible to the system during offline periods.

Candidate outputs produced by offline operations are evaluated before any transition back to online cognition. A candidate set is generated from all structures produced during the dreaming interval. An admissibility functional evaluates geometric coherence, curvature compatibility, and structural regularity. A representative admissibility expression is A_adm(T)=λ₁Φ_geom(T)+λ₂Φ_curv(T)+λ₃Φ_reg(T). Structures satisfying a condition such as A_adm(T)<τ are projected into an online memory manifold through a projection operator that identifies a compatible representation. A projection may be defined by a relation such as Π_cur(x)=arg min_y (d_{g_dream}(x, y)²+β|Curv_dream(x)−Curv_cur(y)|). The projection provides an online-compatible candidate that does not modify persistent memory until a later evaluative process external to the dreaming engine renders a retention decision.

A strict isolation mechanism prevents any dreamspace activity from influencing online cognitive manifolds during the offline interval. During dreaming, online manifolds remain fixed under conditions such as d/dt M_cur(t)=0 and d/dt M_i(t)=0 for manifolds associated with cognitive and metacognitive state. Access by offline generative processes to any online manifold is blocked, ensuring that speculative structures do not propagate into active reasoning systems.

The invention may also operate within a federated cognitive setting in which multiple cognitive systems perform dreaming concurrently. Each system constructs a local dreamspace manifold, and a federated dreaming space may be formed as a product manifold across systems. A federated exploration potential may incorporate system-level divergences, for example using an expression V_fed(x₁, . . . , x_N)=Σ_i V_explore\hat{ }{(i)}(x_i)+Σ_{i<j} φ(D_cur\hat{ }{(i,j)}, D_metric\hat{ }{(i,j)}, D_found\hat{ }{(i,j)}). Joint dreaming dynamics such as dX(t)=−∇V_fed(X(t)) dt+Σ_fed (X(t)) dW_t promote coordinated exploration across systems. Dream-generated structures from different systems may be recombined to produce cross-instance constructs, and shared hypothesis trajectories may be generated by expressions such as γ_e_shared(t)=(1/N) Σ_i γ_e\hat{ }{(i)}(t). Alignment operators compare differing dreamspace geometries across systems without influencing online cognitive structures.

The foregoing description provides a detailed account of the system architecture, geometric constructs, stochastic flows, generative mechanisms, annealing processes, topological perturbations, projection procedures, isolation controls, and federated operations that characterize the dreaming and offline adaptation engine. All examples and formulations are representative rather than limiting, and variations consistent with the principles of offline generative manifold evolution are within the scope of the invention.

The dreaming architecture further employs a dreaming energy functional that characterizes the trade-off between adherence to known cognitive dynamics and exploratory deviation within the dreamspace. A representative formulation for this functional is E_dream[γ_e]=∫₀^{T}∥\dot{γ}_e(t)+λf_real(γ(t))∥² dt+σ∫₀^{T}∥η(t)∥² dt, where γ_e(t) is a counterfactual trajectory, f_real is a drift field associated with online cognition, λ controls the level of adherence to online dynamics, σ scales a stochastic perturbation term, and η(t) represents random variation. This functional establishes how strongly a counterfactual path diverges from or aligns with prior structure during offline evolution. A related trajectory diversity functional expresses the degree to which a counterfactual trajectory departs from online cognitive evolution. One illustrative expression is D(γ_e)=∫₀^{T}∥\dot{γ}_e(t)−f_real(γ(t)∥² dt. This diversity functional provides a mechanism for adjusting exploratory breadth by quantifying distance from behavior exhibited during actual cognitive activity.

The dreaming engine is integrated with experiential and metacognitive structures defined in earlier architectures. Experiential representations can be lifted into the dreamspace manifold through an immersion t_exp that preserves local geometric structure while allowing stochastic and generative operations to act on these lifted entities. Resonance signatures derived from experiential geometry, including harmonic fields represented as σ_exp, inform drift fields, potentials, and noise tensors used during offline evolution. Experiential representations structured as fiber bundles with sensory, conceptual, and narrative components are preserved when lifted into the dreamspace, enabling recombination and counterfactual experimentation across multiple representational layers.

The dreaming architecture also respects the manifold hierarchy associated with metacognitive functions. Foundational manifolds that represent system coherence or identity, often expressed as M₁, M₂, and M₃, remain unchanged during dreaming. Dream-generated structures do not modify these manifolds, although divergence information from them may be incorporated into exploratory dynamics or federated coordination. A proposal operator, denoted Ω_dream, can be applied to dream-generated structures to assess compatibility with foundational constraints without introducing updates to those structures. This operator provides a mechanism for identifying relationships between speculative constructs and long-term stability requirements while maintaining strict separation between offline and online operation.

Refinement within the dreamspace is guided by a dream potential that establishes affinities or relationships between dreamspace locations and experiential content. An example formulation is V_dream(x)=∫_{M_exp} K(x, y) σ_exp(y) dμ(y), where K is a kernel defining similarity relations, σ_exp is an experiential resonance field, and μ is a measure defined over the experiential manifold. This potential influences annealing behavior and supports formation of attractor-like structures that reflect latent semantic or narrative patterns embedded within the experiential corpus.

The dreaming architecture enables exploration of manifold regions that are unreachable under the geodesic dynamics governing online cognitive operation. Let the dreamspace reachability region be defined as the set of all points in the dreamspace manifold for which there exists a time and a dream-generated trajectory reaching that point. Because the stochastic and perturbative flows of the dreaming engine are not constrained by the drift fields or curvature regularities imposed during online cognition, the dreamspace reachability region may extend substantially beyond any region accessible under online dynamics. This expanded reachability is a direct consequence of the exploratory potential, noise tensor anisotropy, and topological flexibility that characterize the dreamspace manifold. The ability to probe such regions is essential for generating counterfactual proposals that represent genuinely novel cognitive possibilities rather than minor perturbations of existing structure.

The invention further introduces generative perturbation fields acting on the dreamspace manifold. A generative perturbation field is a vector field mapping points on the dreamspace manifold to tangent vectors at those points. These fields deform manifold regions to create speculative structural variants of latent concepts by displacing positions into unexplored manifold regions, expanding local curvature, or altering embedding geometry. Unlike the curvature-smoothing flows associated with online stability mechanisms, generative perturbation fields deliberately increase structural variance. The evolution of a structure under a generative perturbation field follows a differential relation in which the time derivative of the structure equals the perturbation field evaluated at the structure. This mechanism provides an additional pathway for creating speculative manifold configurations that differ qualitatively from structures arising through recombination or annealing alone.

The interface between the dreaming engine and downstream memory-management processes may be characterized by an interface functional that combines the admissibility evaluation performed during dreaming with an evaluation functional associated with downstream curation. Let the interface functional be defined as the sum of a curation-related evaluation applied to a candidate structure and a scaled admissibility functional applied to the same structure. This combined functional is evaluated only when the system returns from offline to online mode. The dreaming engine does not minimize or optimize the curation-related component; it exposes candidate structures to this evaluation only through the interface. This construction formalizes the relationship between generative dreaming and evaluative curation as mathematically distinct operations connected by a well-defined functional interface.

The invention includes a proposal operator that evaluates relationships between dream-generated outputs and foundational constraints without applying modifications to foundational structures. Let the proposal operator be a functional that takes candidate structures generated during dreaming and produces a measure of compatibility or divergence relative to foundational manifold representations. This operator enables the system to assess how speculative constructs relate to long-term identity or doctrinal consistency requirements without altering the foundational manifold during offline operation. The proposal operator may inform subsequent online processes that determine whether dream-generated candidates should influence foundational structure, but the operator itself performs no updates. This construction maintains strict separation between offline exploration and identity-level modification while providing a formal mechanism for relating generative outputs to stability constraints.

The dreaming engine supports hypothesis-generating flows that produce counterfactual trajectories interpretable as hypotheses about unobserved or latent cognitive possibilities. A hypothesis-generating flow evolves a trajectory according to a stochastic differential equation whose drift component is derived from a hypothesis potential reflecting conceptual, experiential, or causal gradients. The hypothesis potential encodes structural relationships or affinities that guide exploration toward regions representing plausible but unobserved cognitive configurations. Trajectories generated under hypothesis-generating flows differ from those produced by pure exploration-potential dynamics in that they are shaped by domain-specific structure rather than visitation density alone. This mechanism enables the dreaming engine to generate structured hypothetical paths encoding novel conceptual relations, narrative possibilities, or causal alternatives not present in the experiential manifold.

The following exemplary embodiments illustrate operation of the dreaming and offline adaptation engine on concrete manifold structures. These embodiments are representative rather than limiting and serve to demonstrate operability of the generative, perturbative, and exploratory operators introduced herein.

In a first exemplary embodiment, a two-dimensional dreamspace manifold is defined as a unit square with a flat Euclidean metric. A narrative trajectory from an experiential manifold is lifted into the dreamspace through an immersion and subjected to a perturbed geodesic flow. A tangent vector is sampled from a distribution weighted by the dream noise tensor and scaled by a perturbation parameter. The exponential map applied at each point along the lifted narrative produces a counterfactual narrative path that preserves coarse semantic alignment while deviating structurally from any narrative encoded in the experiential manifold. Subsequent annealing refines the counterfactual narrative toward a coherent prototype.

In a second exemplary embodiment, a point in the experiential manifold carries a harmonic signature encoding emotional or semantic resonance. A generative perturbation displaces this point into the dreamspace by applying the exponential map with a noise-tensor-scaled tangent vector. The harmonic signature evolves under perturbation by adding a harmonic noise term. Annealing then smooths the perturbed harmonic signature into a stable emotional prototype representing a novel experiential configuration synthesized from existing resonance patterns.

In a third exemplary embodiment, two stored experiential trajectories are recombined through weighted logarithmic interpolation. A time-varying weighting function modulates the contribution of each trajectory, and values of the weighting function exceeding the unit interval permit extrapolation beyond the original manifold region spanned by the input trajectories. The resulting hybrid trajectory explores latent patterns for which no online behavioral trace exists.

In a fourth exemplary embodiment, a dreamspace manifold is initialized as a two-dimensional surface diffeomorphic to a sphere. A handle-attachment surgery is performed along a closed curve, producing a toroidal structure. Annealing dynamics explore the neighborhood of the newly created handle region through stochastic perturbation with decreasing noise amplitude. This embodiment demonstrates speculative topological variations permitted within the dreamspace that remain isolated from stable manifolds used during online cognition.

In a fifth exemplary embodiment, the dreamspace metric undergoes curvature inflation through a flow in which the time derivative of the metric equals a positive scalar multiple of the metric. Geodesic distances expand as a result, enabling exploration of new manifold regions inaccessible under the original metric. Upon return to online operation, only projected and admissible subsets of these expansions may enter downstream evaluation.

In a sixth exemplary embodiment, two persistent cognitive machine instances participate in federated dreaming. A shared speculative trajectory is generated by averaging the counterfactual trajectories produced by each instance, with the average interpreted through the logarithmic map on the product dreamspace manifold. The resulting shared trajectory reflects a collective counterfactual pattern that is subsequently evaluated independently by each instance through its local projection interface.

In a seventh exemplary embodiment, a dream-generated candidate structure is projected back into the memory manifold through the projection operator. The projection satisfies a geometric matching condition that minimizes a combination of distance in the dreamspace metric and curvature deviation between the dreamspace and memory manifold representations. Only after projection do the candidate structures undergo evaluation by downstream processes. This embodiment demonstrates the boundary between offline exploration and online adjudication that characterizes the dreaming architecture.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“A_adm” refers to an admissibility functional computed as a weighted sum of geometric coherence, curvature consistency, and structural regularity measures used to determine whether a dream-generated structure qualifies for projection into a memory manifold.

“Annealing” refers to a process of stochastic refinement in which a candidate structure is iteratively evolved on a manifold with a time-dependent noise amplitude that decreases according to a cooling schedule, enabling convergence toward low-potential attractors.

“Attractor” refers to a structurally stable configuration within the dreamspace manifold toward which annealed structures converge during offline operation, representing emergent high-level abstractions or generalizable templates.

“Bundle” refers to a collection of related points or structures in a manifold that includes decomposable components such as sensory (E), conceptual (C), and narrative (N) fibers, consistent with the experiential architecture defined in the parent application.

“Candidate structure” refers to a geometric or topological entity produced by the dreaming and offline adaptation engine during offline operation that is evaluated for admissibility prior to being projected into a memory manifold.

“Cooling schedule” refers to a parameterized function, typically exponential, that governs the rate at which the noise amplitude σ(t) decreases during annealing, thereby regulating the exploration-to-convergence dynamics.

“Counterfactual trajectory” refers to a synthesized manifold path that deviates from stored experiential or cognitive trajectories, generated via mechanisms such as perturbed geodesic shooting or drift inversion.

“Dreamspace manifold” refers to a dedicated geometric manifold, distinct from experiential or cognitive manifolds, on which stochastic, generative, and perturbative operations are performed exclusively during offline operation.

“E⊕C⊕N” refers to a fiber decomposition of an experiential bundle into sensory (E), conceptual (C), and narrative (N) components, each of which may be independently manipulated or recombined in the dreamspace manifold.

“Federated dreaming” refers to a coordinated process in which multiple cognitive system instances participate in synchronized offline dreaming, jointly evolving a product manifold and generating shared or recombined structures across agents.

“Geodesic perturbation” refers to the modification of a trajectory by applying a perturbation vector within the tangent space of a manifold and mapping the result through the exponential map to produce a divergent path.

“Hypothesis flow” refers to a trajectory generated by gradient descent on a latent potential function derived from internal dreamspace relationships, enabling exploration of abstract or speculative representational structures.

“Immersion map” refers to a function, such as ι_exp, that lifts experiential or cognitive structures into the dreamspace manifold while preserving local geometric relations.

“Offline epoch” refers to a discrete time interval during which the system suspends online cognitive operations and activates the dreaming and offline adaptation engine for generative processing in an isolated mode.

“Π_cur” refers to a projection operator that maps structures from the dreamspace manifold into the memory manifold by minimizing a composite distance metric and curvature difference.

“Persistent cognitive machine” refers to a computational system configured to maintain, evolve, and act upon structured cognitive and experiential representations over time, including one or more manifolds, bundles, or memory constructs that persist across operational cycles, and capable of supporting manifold-based inference, memory encoding, and metacognitive regulation as described in the parent architecture.

“Product manifold” refers to a geometric space constructed as the Cartesian product of local dreamspace manifolds from multiple instances, supporting joint stochastic evolution and cross-agent synthesis in a federated context.

“Projection” refers to the act of mapping an admissible candidate structure from the dreamspace manifold into the memory manifold using the operator Π_cur, without directly modifying persistent memory.

“Resonance signature” refers to a field or scalar function derived from the experiential manifold that encodes harmonic, narrative, or structural salience and is used to influence noise, potential, or refinement dynamics.

“Shared hypothesis trajectory” refers to a cross-instance trajectory computed by averaging counterfactual trajectories from multiple agents in a product manifold, typically using logarithmic map operations to ensure geometric consistency.

“Stochastic dreaming flow” refers to the evolution of states within the dreamspace manifold governed by a stochastic differential equation combining an exploration-driven drift component and a curvature-informed noise component.

“T_cand” refers to the set of candidate structures generated by the dreaming engine during an offline epoch, prior to admissibility evaluation.

“\hat{T}” refers to the admissible subset of T_cand that satisfies A_adm<τ and is eligible for projection into the memory manifold upon completion of offline processing.

“Transient buffer” refers to a temporary storage structure that holds admissible projected candidates (\hat{T}) until the system transitions back to online operation, at which point candidates may be evaluated for integration.

“V_dream” refers to a scalar potential function computed over the dreamspace manifold based on similarity to experiential resonance signatures, used to guide annealing and attractor formation.

“V_explore” refers to a scalar potential function over the dreamspace manifold that inversely reflects prior visitation frequency, thereby encouraging exploration of underrepresented representational regions.

### Conceptual Architecture

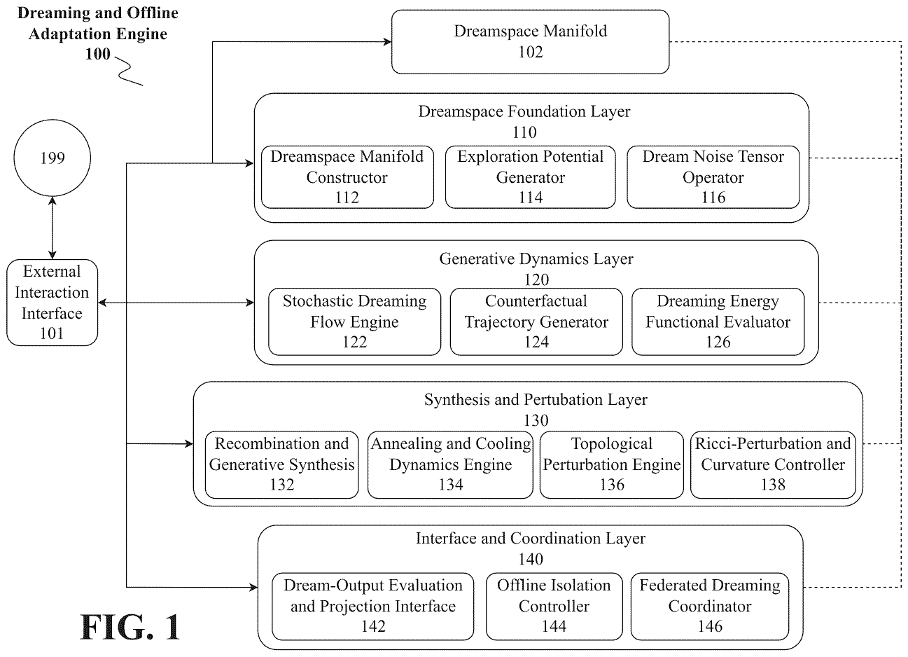

FIG. 1 is a block diagram illustrating an exemplary architecture of a dreaming and offline adaptation engine 100, in an embodiment. The dreaming and offline adaptation engine 100 operates exclusively during offline periods to conduct stochastic, perturbative, and generative evolution of cognitive and experiential structures on a dedicated geometric manifold. The architecture comprises four functional layers organized around a dreamspace manifold 102, which provides the geometric workspace for offline adaptation processes. A dreamspace foundation layer 110 initializes geometric and exploratory parameters for the dreamspace manifold 102. A generative dynamics layer 120 governs stochastic and deterministic manifold evolution. A synthesis and perturbation layer 130 performs recombinative, structural, and topological modifications of dreamspace entities. An interface and coordination layer 140 manages boundary conditions, evaluation, interfacing, and optional multi-instance coordination with external elements 199.

A dreamspace manifold 102 serves as the geometric substrate on which offline evolution of cognitive and experiential structures occurs. The dreamspace manifold 102 is distinct from online cognitive manifolds and is equipped with a metric g_dream defining distances, curvature, and neighborhood structure. Prior to commencement of offline operation, experiential structures, resonance fields, visitation-density information, or structural seeds may be received through an external interaction interface 101, which provides a controlled pathway for importing such information into components of the dreamspace foundation layer 110. The geometry of the dreamspace manifold 102 is configured to support stochastic perturbation, dimensional variation, curvature modification, and controlled topological changes that are not applied to manifolds used during online cognitive operation. The dreamspace manifold 102 receives initialization inputs from the dreamspace foundation layer 110 and dynamical updates from the generative dynamics layer 120, while structures represented within the dreamspace manifold 102 are processed further by the synthesis and perturbation layer 130 and subsequently evaluated by the interface and coordination layer 140.

A dreamspace foundation layer 110 establishes the geometric and exploratory substrate on which dreaming operations occur. In an embodiment, the layer comprises three components. A dreamspace manifold constructor 112 initializes data structures defining the geometry of the dreamspace manifold 102, including metric tensors, tangent bundles, and coordinate charts. The constructor 112 may receive structural parameters or experiential signatures through the external interaction interface 101. An exploration potential generator 114 computes an exploration potential V_explore that biases manifold evolution toward regions of lower visitation density, promoting exploration of underrepresented representational states. A dream noise tensor operator 116 generates a state-dependent noise tensor Σ_dream that maps stochastic increments into tangent vectors on the dreamspace manifold 102, with the tensor incorporating curvature-derived information from g_dream to shape anisotropic perturbations. Outputs from the foundation layer 110 supply geometric initialization, drift-defining fields, and noise characteristics for use by downstream layers.

A generative dynamics layer 120 implements stochastic and deterministic flows governing evolution within the dreamspace manifold 102. A stochastic dreaming flow engine 122 advances dreamspace states using numerical integration of stochastic differential equations whose drift component incorporates the exploration potential and whose noise component is derived from the noise tensor. The stochastic dreaming flow engine 122 generates evolved state trajectories X(t) that explore regions not encountered during online operation. A counterfactual trajectory generator 124 receives state information produced by the flow engine 122 and generates counterfactual trajectories \tilde{γ}(t) through mechanisms such as perturbed geodesic operations or inversion of online drift fields. A dreaming energy functional evaluator 126 computes energy and diversity metrics characterizing the similarity or deviation of counterfactual trajectories relative to online cognitive dynamics, enabling regulation of exploratory breadth. Structures and trajectories generated by the generative dynamics layer 120 populate the dreamspace manifold 102 for further operations by the synthesis and perturbation layer 130.

A synthesis and perturbation layer 130 applies generative, recombinative, and structural modification procedures to geometric entities within the dreamspace manifold 102. A recombination and generative synthesis engine 132 performs manifold-aware blending, interpolation, and trajectory-combination procedures to produce hybrid or extrapolated structures T_new not present in stored experiential manifolds or memory systems. An annealing and cooling dynamics engine 134 refines generative outputs through stochastic perturbation with a decreasing noise amplitude according to a cooling schedule, producing coherent structures or attractor-like configurations. A topological and structural perturbation engine 136 applies controlled manifold-modification procedures including localized surgery operations, hole formation or collapse, and branching or duplication of manifold sheets. A Ricci-perturbation and curvature evolution controller 138 evolves the metric g_dream based on curvature-inflation processes and perturbative Ricci adjustments that expand the geometric representational capacity of the dreamspace manifold 102. Outputs generated by the synthesis and perturbation layer 130 form a set of candidate structures T_cand for evaluation.

An interface and coordination layer 140 manages evaluation, isolation, and inter-system coordination. An external interaction interface 101 provides the entry and exit point for all exchanges with external elements 199. Through the external interaction interface 101, experiential structures, resonance signatures, visitation-density data, or other seeds may be delivered to the dreamspace foundation layer 110 during initialization of an offline epoch. A dream-output evaluation and projection interface 142 receives candidate structures T_cand, evaluates geometric admissibility using criteria that may include geometric coherence, curvature consistency, and structural regularity, and projects admissible structures \hat{T} for eventual consideration during subsequent online cognitive operation. The projection interface 142 does not directly modify persistent memory. An offline isolation controller 144 is configured to prevent dream-generated structures from altering online cognitive manifolds during operation of the dreaming engine 100 and supports invariance of online cognitive structures throughout the offline epoch by regulating interactions between internal dreaming processes and external elements 199. A federated dreaming coordinator 146 supports coordination of dreaming operations across multiple cognitive system instances by constructing product dreamspace manifolds, computing federated exploration potentials, and generating shared hypothesis trajectories.

External elements 199 represent structures outside the dreaming and offline adaptation engine 100, such as experiential manifolds, online cognitive manifolds, persistent memory systems, and peer cognitive systems in a federated configuration. External elements 199 provide inputs through the external interaction interface 101 and may receive projected candidate structures \hat{T} following completion of offline adaptation. During the offline epoch, the offline isolation controller 144 is configured to maintain invariance of online cognitive manifolds and to restrict direct influence of dreamspace processes on external elements 199, thereby supporting stable offline exploratory operation.

In an embodiment, data flow within the dreaming and offline adaptation engine 100 begins when the system transitions into an offline epoch following cessation of online cognitive activity within a persistent cognitive machine. During this transition, the external interaction interface 101 receives structural seeds from experiential manifolds that may include multimodal embeddings, harmonic resonance signatures, narrative trajectory data, and fiber-bundle representations organized according to sensory, conceptual, and narrative components as defined in an experiential manifold architecture of the persistent cognitive machine. Visitation-density information reflecting regions of the experiential manifold traversed during prior online operation may also be received to inform computation of exploration potentials. The dreamspace foundation layer 110 processes these inputs to initialize the dreamspace manifold 102, establishing metric tensors, tangent-bundle structures, and coordinate parameterizations appropriate for offline exploratory evolution. Once initialization is complete, the generative dynamics layer 120 advances dreamspace states through stochastic differential flows and counterfactual trajectory generation, producing geometric paths and state evolutions that diverge from trajectories accumulated during online cognitive operation. The synthesis and perturbation layer 130 applies recombination operators, annealing dynamics, and topological modifications to these generated structures, yielding a set of candidate structures T_cand representing novel geometric constructs not derivable from experiential manifolds or stored memory alone. The dream-output evaluation and projection interface 142 then evaluates candidate structures for geometric admissibility and projects admissible structures \hat{T} into a form suitable for later evaluation, without directly modifying persistent memory or the metacognitive manifold hierarchy that governs cognitive coherence and identity within the persistent cognitive machine. Throughout the offline epoch, the offline isolation controller 144 maintains invariance of online cognitive manifolds including foundational, mesoscale, and cognitive-surface manifolds of the metacognitive fabric. When the dreaming and offline adaptation engine 100 operates as one instance among a plurality of persistent cognitive machine instances in a federated configuration, the federated dreaming coordinator 146 constructs a product dreamspace manifold spanning participating instances, computes federated exploration potentials that incorporate cross-instance divergence measures derived from metacognitive alignment frameworks, and supports generation of shared hypothesis trajectories through coupled stochastic exploration across the federated dreamspace. Upon return to online operation, projected candidate structures \hat{T} become available for evaluation by downstream processes external to the dreaming engine, while the dreamspace manifold 102 and its intermediate structures do not persist into online cognitive activity. This architecture supports structured exploratory expansion of representational geometry during offline periods while preserving stability of online cognitive operation and maintaining compatibility with the broader persistent cognitive machine framework.

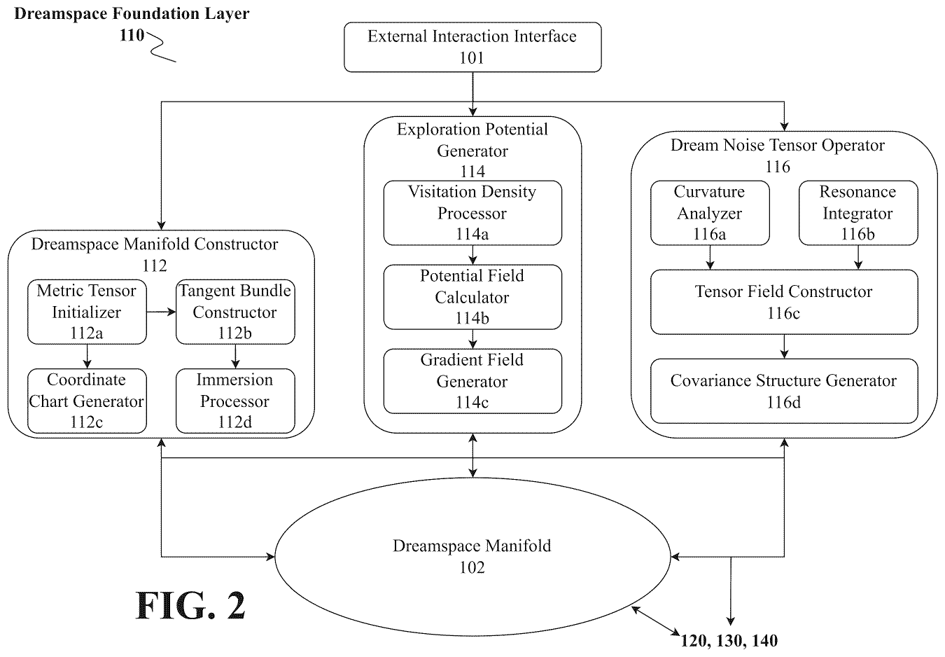

FIG. 2 is a block diagram illustrating a dreamspace foundation layer 110 of a dreaming and offline adaptation engine, in an embodiment. The dreamspace foundation layer 110 establishes geometric and exploratory parameters for a dreamspace manifold 102 and comprises three primary components that receive inputs through an external interaction interface 101 and supply initialization data, potential fields, and noise characteristics to the dreamspace manifold 102. These components include a dreamspace manifold constructor 112, an exploration potential generator 114, and a dream noise tensor operator 116, each producing computational structures and numerical fields that define the geometric substrate on which subsequent offline dreaming operations are performed.

An external interaction interface 101 is positioned at an input boundary of the dreamspace foundation layer 110 and receives data from external elements at the onset of an offline epoch. Inputs received through the external interaction interface 101 may include structural seeds derived from experiential manifolds, visitation-density information ρ(x) reflecting regions traversed during prior online cognitive operation, and resonance signatures σ_exp encoding harmonic or semantic characteristics of experiential content. The external interaction interface 101 provides these inputs to appropriate components of the dreamspace foundation layer 110 according to their computational role in initializing the dreamspace manifold 102.

A dreamspace manifold constructor 112 generates numerical structures defining the geometry of the dreamspace manifold 102. The dreamspace manifold constructor 112 includes a metric tensor initializer 112a that computes and stores values for a metric g_dream governing distances and curvature within the dreamspace, a tangent bundle constructor 112b that numerically specifies tangent spaces using basis vectors compatible with the initialized metric, a coordinate chart generator 112c that computes local coordinate parameterizations used for tensor and gradient operations, and an immersion processor 112d that applies geometric mappings to lift experiential or cognitive structures into the dreamspace while preserving selected relational or semantic features. The metric tensor initializer 112a receives structural seeds and experiential data through the external interaction interface 101 and produces a metric tensor g_dream supplied to downstream components and to the dreamspace manifold 102. The tangent bundle constructor 112b cooperates with the metric tensor initializer 112a by generating tangent-space representations consistent with the selected metric structure.

An exploration potential generator 114 computes an exploration potential V_explore that biases subsequent manifold evolution toward regions of lower visitation density. The exploration potential generator 114 comprises a visitation-density processor 114a that processes density values ρ(x) received through the external interaction interface 101, a potential-field calculator 114b that computes the potential using a formulation such as V_explore(x)=−log(ρ(x)+ε), where ε is a regularization parameter, and a gradient-field generator 114c that computes the gradient ∇V_explore using coordinate representations derived from the metric g_dream. The exploration potential generator 114 receives metric information from the dreamspace manifold constructor 112 to ensure that gradient computation aligns with the geometry of the dreamspace manifold 102. Outputs from the exploration potential generator 114 include the exploration potential field V_explore and its gradient ∇V_explore, which flow to the dreamspace manifold 102 and inform drift fields used by downstream stochastic-evolution subsystems operating during offline periods.

A dream noise tensor operator 116 generates a state-dependent noise tensor Σ_dream that maps stochastic increments into tangent vectors on the dreamspace manifold 102. The dream noise tensor operator 116 includes a curvature analyzer 116a that computes local curvature characteristics using the metric g_dream and associated curvature tensors, a resonance integrator 116b that incorporates resonance signatures σ_exp received through the external interaction interface 101 to influence stochastic anisotropy, a tensor-field constructor 116c that generates numeric representations of Σ_dream across discrete manifold regions, and a covariance-structure generator 116d that computes anisotropic dispersion characteristics based on geometric curvature and resonance-derived information. The curvature analyzer 116a receives metric and curvature information from the dreamspace manifold constructor 112, while the resonance integrator 116b incorporates semantic or harmonic signatures into the stochastic model. The resulting noise tensor Σ_dream has the form Σ_dream(x): R\hat{ }k→T_xM_dream, mapping k-dimensional stochastic increments into tangent-space vectors consistent with the geometry of the dreamspace manifold 102.

A dreamspace manifold 102 receives outputs from the dreamspace manifold constructor 112, the exploration potential generator 114, and the dream noise tensor operator 116. The metric g_dream and tangent bundle TM_dream define the geometric structure used for representing offline states and trajectories. The exploration potential V_explore and its gradient ∇V_explore supply drift characteristics that bias subsequent stochastic evolution toward less-visited manifold regions. The noise tensor Σ_dream defines the anisotropic stochastic dispersion applied during manifold evolution. Once initialization is complete, the dreamspace manifold 102 and its associated fields are made available to a generative dynamics layer 120 for offline stochastic evolution, counterfactual trajectory generation, and other dreaming processes performed while online cognitive manifolds remain invariant.

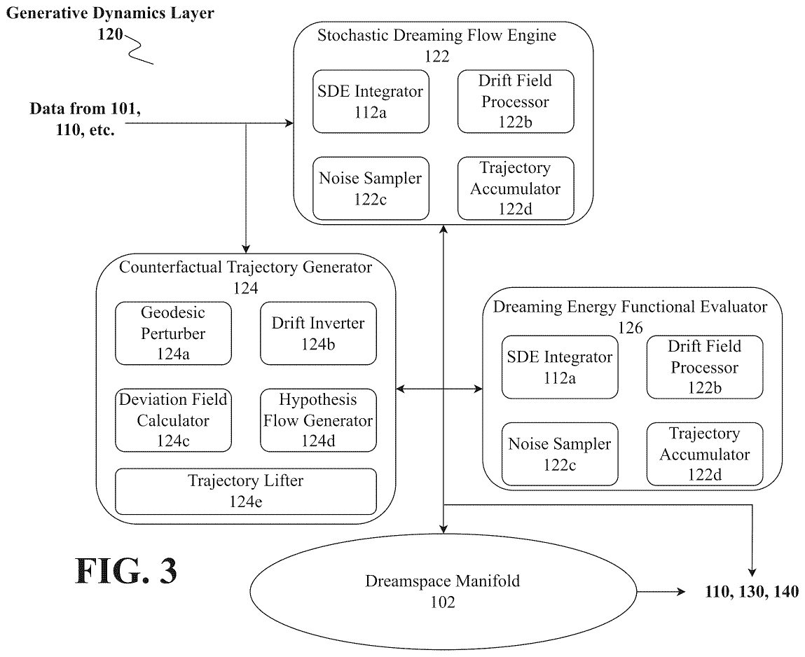

FIG. 3 is a block diagram illustrating exemplary architecture of a generative dynamics layer 120 within a dreaming and offline adaptation engine 100, in an embodiment. The generative dynamics layer 120 implements stochastic and deterministic flows that govern evolution of states within a dreamspace manifold 102 exclusively during offline operation. The layer comprises three primary components that receive geometric and exploratory parameters from a dreamspace foundation layer 110 and produce evolved trajectories, counterfactual paths, and evaluative metrics for downstream processing by a synthesis and perturbation layer 130. These components include a stochastic dreaming flow engine 122, a counterfactual trajectory generator 124, and a dreaming energy functional evaluator 126, each operating on geometric entities represented within the dreamspace manifold 102.

A stochastic dreaming flow engine 122 advances dreamspace states according to stochastic differential equations whose drift and noise components are derived from inputs supplied by the dreamspace foundation layer 110. The stochastic dreaming flow engine 122 comprises an SDE integrator 122a configured to apply manifold-adapted numerical solvers for computing successive state updates on the dreamspace manifold 102, a drift field processor 122b that derives drift vectors from the exploration potential and any perturbation fields defined for the offline epoch, a noise sampler 122c that produces stochastic increments and maps them through the noise tensor into tangent vectors consistent with the local geometry, and a trajectory accumulator 122d that records the resulting state evolution X(t) in a discrete trajectory representation suitable for downstream geometric operations. The SDE integrator 122a receives a drift field f_dream from the drift field processor 122b and stochastic increments from the noise sampler 122c, combining these according to a flow relation such as dX(t)=f_dream(X(t)) dt+Σ_dream(X(t)) dW_t. The trajectory accumulator 122d collects the computed state sequence X(t) and supplies these trajectories both to the counterfactual trajectory generator 124 and to output interfaces for the synthesis and perturbation layer 130.

A counterfactual trajectory generator 124 receives evolved state trajectories from the stochastic dreaming flow engine 122 and stored experiential or cognitive trajectories γ(t) sourced from experiential or memory manifolds, and produces counterfactual trajectories \tilde{γ}(t) representing hypothetical manifold paths that deviate from previously observed experience. The counterfactual trajectory generator 124 comprises a geodesic perturber 124a that generates perturbed geodesic rays using exponential-map computations of the form \tilde{γ}(t)=exp_{γ(t)}(ε v(t)), a drift inverter 124b that constructs counterflow trajectories by applying inverted versions of online drift fields according to relations such as [symbol] (t)=−f_real(γ(t))+δ(t), a deviation field calculator 124c that evaluates curvature-dependent differential relations to compute geodesic deviation fields J(t), a hypothesis flow generator 124d that produces structured exploratory paths guided by potentials or latent relationships derived from dreamspace geometry, and a trajectory lifter 124e that embeds stored trajectories into higher-dimensional dreamspace coordinates to enable exploration along latent degrees of freedom. The geodesic perturber 124a and drift inverter 124b operate in complementary fashion to create counterfactual paths through distinct geometric mechanisms, while the deviation field calculator 124c quantifies divergence between \tilde{γ}(t) and γ(t) using curvature properties derived from the dreamspace metric.

A dreaming energy functional evaluator 126 receives counterfactual trajectories from the counterfactual trajectory generator 124 and state-evolution data from the stochastic dreaming flow engine 122, and computes metrics characterizing the relationship between dream-generated trajectories and online cognitive dynamics. The dreaming energy functional evaluator 126 comprises an energy functional calculator 126a that numerically evaluates an expression of the form E_dream[\tilde{γ}]=∫₀^{T}∥ [symbol] (t)+λ f_real(γ(t)∥² dt+σ∫₀^{T}∥η(t)∥² dt, a diversity metric evaluator 126b that computes a functional such as D(\tilde{γ})=∫₀^{T}∥ [symbol] (t)−f_real(γ(t))∥² dt to measure departure from online cognitive flows, a gradient computer 126c that generates gradient information of these functionals using differentiation rules consistent with the dreamspace metric, and an exploration regulator 126d that adjusts the breadth of exploratory generation in subsequent cycles based on computed energy and diversity characteristics. The exploration regulator 126d may provide adaptive feedback signals to the counterfactual trajectory generator 124, enabling controlled variation in counterfactual synthesis over the course of an offline dreaming interval.

Data flow within the generative dynamics layer 120 proceeds from geometric and exploratory parameters received from the dreamspace foundation layer 110 through successive processing stages. The stochastic dreaming flow engine 122 receives the drift field f_dream, noise tensor Σ_dream, exploration potential V_explore, metric g_dream, and initial state X(0), and produces evolved state trajectories X(t) that populate the dreamspace manifold 102. These trajectories flow to the counterfactual trajectory generator 124, which also receives stored experiential or cognitive trajectories γ(t). The counterfactual trajectory generator 124 produces counterfactual trajectories \tilde{γ}(t) and deviation fields J(t) that flow to the dreaming energy functional evaluator 126 for evaluation of energy and diversity metrics. Outputs from the generative dynamics layer 120, including evolved trajectories X(t), counterfactual trajectories \tilde{γ}(t), energy values E_dream, diversity metrics D(\tilde{γ}), and deviation fields J(t), are transmitted to the synthesis and perturbation layer 130 for recombinative, annealing, and structural modification operations. Throughout these processes, the dreamspace manifold 102 provides the geometric substrate governing all state evolution and trajectory construction, with the manifold's metric structure determining distance relations, geodesic computations, and curvature-dependent operations performed by components of the generative dynamics layer 120.

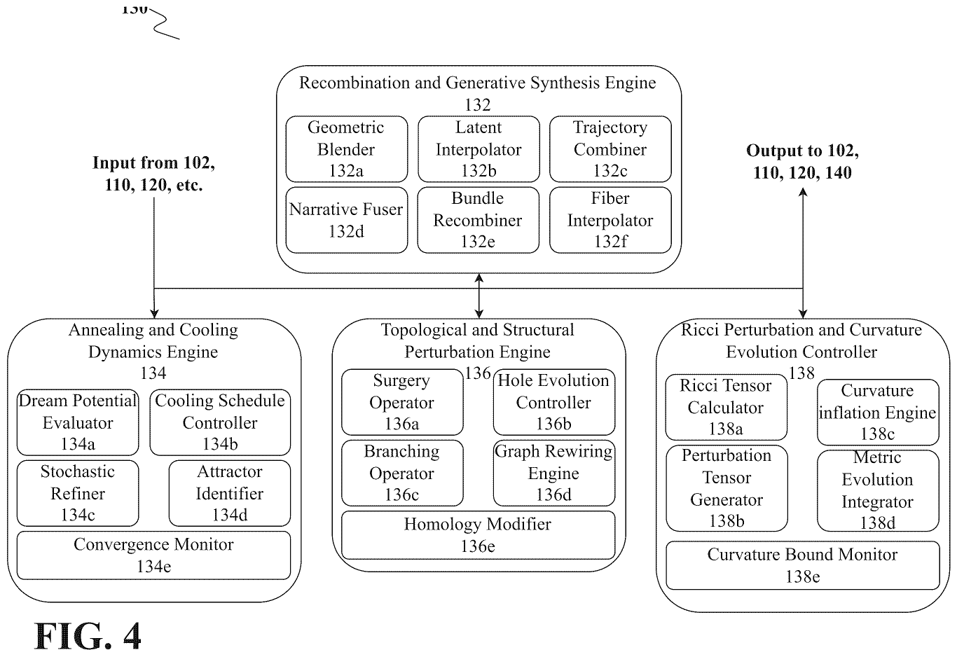

FIG. 4 is a block diagram illustrating exemplary architecture of a synthesis and perturbation layer 130 within a dreaming and offline adaptation engine 100, in an embodiment. The synthesis and perturbation layer 130 applies generative, recombinative, and structural modification procedures to geometric entities represented within a dreamspace manifold 102 during offline operation. The layer comprises four primary components that receive trajectories, counterfactual paths, and evaluative metrics from a generative dynamics layer 120, as well as metric and resonance information from a dreamspace foundation layer 110, and produce candidate structures for evaluation by an interface and coordination layer 140. These components include a recombination and generative synthesis engine 132, an annealing and cooling dynamics engine 134, a topological and structural perturbation engine 136, and a Ricci-perturbation and curvature evolution controller 138, each transforming stored geometric data structures according to manifold-aware computational procedures.

A recombination and generative synthesis engine 132 performs manifold-aware blending, interpolation, and combination procedures to produce hybrid or extrapolated structures not present in stored experiential manifolds or memory systems. The recombination and generative synthesis engine 132 comprises a geometric blender 132a that applies numerical exponential-map and logarithmic-map routines to generate interpolated structures along geodesic paths according to expressions such as Blend_λ(T₁, T₂)=exp_{T₁}(λ log_{T₁}(T₂)), a latent interpolator 132b that performs extrapolatory interpolation using coordinate-based evaluations of relations such as I_α(x, y)=exp_x(α log_x(y)), a trajectory combiner 132c that constructs hybrid trajectories by evaluating weighted logarithmic differences of the form γ_comb(t)=exp_{γ₁(t)}(θ(t)log_{γ₁(t)}γ₂ (t)), a narrative fuser 132d that applies interpolation rules to narrative-trajectory representations using position-dependent weighting functions, a bundle recombiner 132e that constructs recombined experiential bundles by applying blending operations across bundle elements represented in fiber-decomposed structures, and a fiber interpolator 132f that performs fiberwise interpolation of sensory, conceptual, and narrative components using manifold-coordinate representations. These processes rely on tensor operations and coordinate charts associated with the dreamspace manifold 102 and receive memory structures T₁ and T₂ either from dreamspace storage or via lifting operations applied to experiential or cognitive structures.

An annealing and cooling dynamics engine 134 refines generative outputs through stochastic perturbation with a decreasing noise amplitude, producing coherent structures or attractor-like configurations within the dreamspace manifold 102. The annealing and cooling dynamics engine 134 comprises a dream potential evaluator 134a that computes numerical approximations of a potential V_dream based on experiential similarity kernels and resonance signatures according to relations such as V_dream(x)=∫_{M_exp} K(x, y) σ_exp(y) dμ(y), a cooling schedule controller 134b that generates a time-varying temperature σ(t) according to schedules such as σ(t)=σ₀ e\hat{ }{−αt}, a stochastic refiner 134c that evolves candidate structures by applying coordinate-based updates of the form dT/dt=−∇V_dream(T)+σ(t) η(t), an attractor identifier 134d that detects convergence of refined structures toward numerically stable low-potential basins A_dream, and a convergence monitor 134e that tracks progression toward convergence criteria during the annealing interval. The dream potential evaluator 134a receives resonance signatures σ_exp through upstream interfaces, while the stochastic refiner 134c receives synthesized structures T_new from the recombination and generative synthesis engine 132 for refinement.

A topological and structural perturbation engine 136 applies controlled manifold-modification procedures that expand representational capacity of the dreamspace manifold 102 through localized topological and structural changes. The topological and structural perturbation engine 136 comprises a surgery operator 136a that performs discrete approximations of excision, gluing, or handle-attachment operations on stored representations of open sets U⊂M_dream to produce modified manifolds M′_dream=S(M_dream, U), a hole evolution controller 136b that manages numerical representations of topological holes through updates to a scalar field φ(x, t) satisfying relations such as ∂φ/∂t=ζ₁(x, t)−ζ₂(x, t) φ(x, t), a branching operator 136c that generates speculative manifold sheets by applying coordinate-based expansions of stored manifold regions using constructions such as M_dream∪exp_W(ε Z), a graph rewiring engine 136d that modifies adjacency matrices or edge sets for graph-embedded subregions based on generative compatibility scores, and a homology modifier 136e that tracks changes to discrete homology descriptors representing local topological structure. These operations are implemented on discrete manifold data structures stored in memory and produce modified geometric regions that flow to subsequent metric-evolution processes.

A Ricci-perturbation and curvature evolution controller 138 governs evolution of dreamspace metric geometry through curvature-based flows with perturbative injections that support curvature inflation and exploration of non-standard geometric configurations. The Ricci-perturbation and curvature evolution controller 138 comprises a Ricci tensor calculator 138a that computes approximate Ricci curvature values Ric(g_dream) using coordinate-based differentiation of the stored dreamspace metric, a perturbation tensor generator 138b that produces perturbation tensors Γ(x, t) representing curvature-modifying influences, a curvature inflation engine 138c that applies metric updates supporting curvature expansion according to relations such as ∂g_dream/∂t=α g_dream+Γ(x, t), a metric evolution integrator 138d that performs time-stepped numerical integration of Ricci-perturbation flows of the form ∂g_dream/∂t=−2 Ric(g_dream)+Γ(x, t), and a curvature bound monitor 138e that tracks curvature magnitude and regularity to maintain geometric coherence during evolution. The Ricci tensor calculator 138a receives updated metric information from the dreamspace manifold 102 and from modified manifold regions produced by the topological and structural perturbation engine 136, while the metric evolution integrator 138d supplies evolved metric tensors g_dream(t) to components requiring updated geometric information.

Data flow within the synthesis and perturbation layer 130 proceeds from upstream inputs through parallel and sequential transformation stages. The recombination and generative synthesis engine 132 receives trajectories X(t), counterfactual trajectories \tilde{γ}(t), and experiential bundles B₁, B₂, and produces blended structures T_new and combined trajectories γ_comb that flow both to output interfaces and to the annealing and cooling dynamics engine 134 for refinement. The annealing and cooling dynamics engine 134 produces refined structures and emergent attractor configurations A_dream. The topological and structural perturbation engine 136 receives metric information g_dream and produces modified manifold regions M′_dream that are processed by the Ricci-perturbation and curvature evolution controller 138 to update the metric structure. The Ricci-perturbation and curvature evolution controller 138 produces evolved metric tensors g_dream(t) that feed back to the topological and structural perturbation engine 136 and to the annealing and cooling dynamics engine 134 for curvature-aware processing. Outputs from the synthesis and perturbation layer 130, including blended structures T_new, combined trajectories γ_comb, attractor configurations A_dream, modified manifold regions M′_dream, and evolved metric tensors g_dream(t), are transmitted to the interface and coordination layer 140 for admissibility evaluation and projection. Throughout these procedures, the dreamspace manifold 102 functions as the underlying geometric substrate on which synthesis and perturbation operations occur, with all geometric and topological modifications remaining confined to offline dreaming epochs and isolated from online cognitive manifolds.

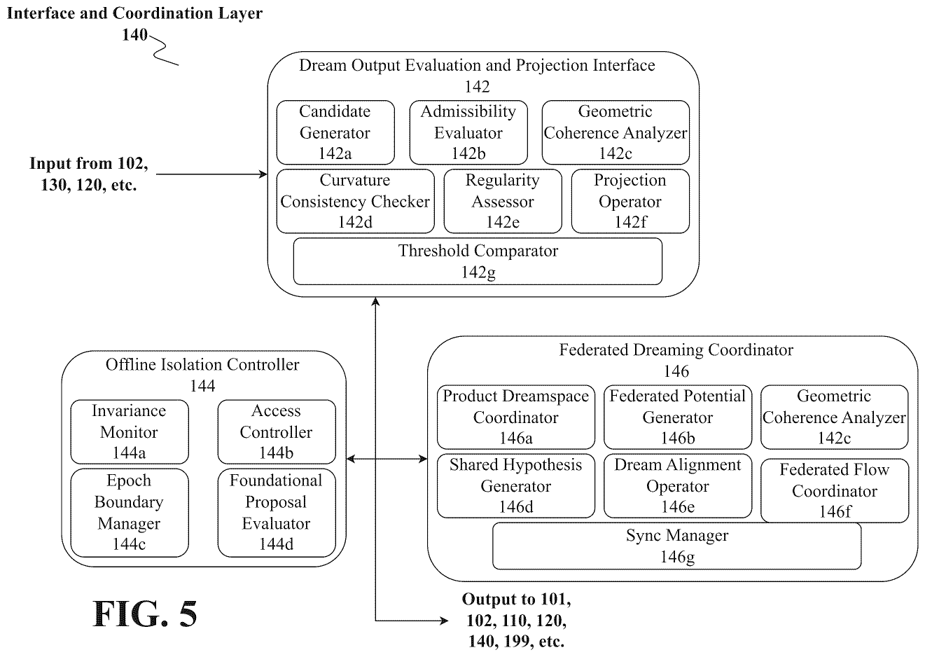

FIG. 5 is a block diagram illustrating exemplary architecture of an interface and coordination layer 140 within a dreaming and offline adaptation engine 100, in an embodiment. The interface and coordination layer 140 manages evaluation of dream-generated structures, enforces isolation between offline dreaming operations and online cognitive manifolds, and coordinates federated dreaming across multiple cognitive system instances. The layer comprises three primary components that receive candidate structures from a synthesis and perturbation layer 130 and mediate interactions with external elements 199 through an external interaction interface 101. These components include a dream-output evaluation and projection interface 142, an offline isolation controller 144, and a federated dreaming coordinator 146, each implementing computational mechanisms for filtering, boundary regulation, or cross-agent coordination.

A dream-output evaluation and projection interface 142 receives candidate structures generated by upstream dreaming subsystems and evaluates their geometric admissibility for potential consideration during subsequent online operation. The dream-output evaluation and projection interface 142 comprises a candidate generator 142a that aggregates outputs from the synthesis and perturbation layer 130 into a candidate set T_cand using an operator G_dream that collects structured data representations of points, curves, surfaces, bundles, and perturbed manifold regions generated during the offline epoch. An admissibility evaluator 142b computes an admissibility functional A_adm(T)=λ₁ Φ_geom(T)+λ₂ Φ_curv(T)+λ₃ Φ_reg(T), where Φ_geom, Φ_curv, and Φ_reg are computed using numerical evaluations over stored geometric representations. A geometric coherence analyzer 142c computes Φ_geom by evaluating metric-aligned distances and structural correspondences between dream-generated structures and regions of the online memory manifold M_cur. A curvature consistency checker 142d computes Φ_curv using curvature estimates derived from the dreamspace metric g_dream and compares them to admissible curvature bounds associated with the memory manifold. A regularity assessor 142e evaluates Φ_reg by checking discrete continuity, completeness, and representational regularity of candidate structures. A projection operator 142f maps admissible structures from the dreamspace manifold into the memory manifold using a numerical minimization procedure associated with Π_cur(x)=arg min_{y∈M_cur} [d_{g_dream}(x, y)²+β|Curv_dream(x)−Curv_cur(y)|], and a threshold comparator 142g identifies structures satisfying A_adm(T)<τ. The projection operator 142f outputs projected candidate structures \hat{T}, which are stored in a transient holding buffer pending release at the end of the offline epoch.

An offline isolation controller 144 maintains invariance of online cognitive manifolds and persistent memory during operation of the dreaming and offline adaptation engine 100 and manages transitions between offline and online epochs. The offline isolation controller 144 comprises an invariance monitor 144a that tracks state representations of online manifolds M_cur, M₁, M₂, and M₃ and verifies invariance conditions such as d/dt M_cur(t)=0 and d/dt M_i(t)=0 over the interval t∈[t_off, t_on] using detection of write-access attempts or unauthorized modification operations. An access controller 144b intercepts calls, memory writes, or update requests generated by dreaming subsystems and blocks any attempt to modify data structures corresponding to online manifolds or persistent memory components. An epoch boundary manager 144c identifies transitions between online and offline regimes by monitoring global system state and provides synchronization signals t_off and t_on to components of the interface and coordination layer 140. A foundational proposal evaluator 144d computes an optional proposal operator Ω_dream(T_cand) using numerical evaluations of structural compatibility between candidate outputs and stored representations of foundational manifold M₃, but does not modify M₃ or apply updates. The invariance monitor 144a and access controller 144b operate cooperatively to enforce strict separation between offline exploratory processes and online cognitive geometry, while the epoch boundary manager 144c triggers release of projected candidate structures \hat{T} through the external interaction interface 101 only when the system transitions from offline to online operation.

A federated dreaming coordinator 146 manages coordination of dreaming operations across multiple persistent cognitive machine instances operating within a cognitive fabric. The federated dreaming coordinator 146 comprises a product dreamspace constructor 146a that constructs a product-manifold representation M_dream=Π{i=1}\hat{ }{N} M_dream\hat{ }{(i)} using concatenated coordinate systems or composite tensor representations received from participating instances. A federated potential generator 146b computes a federated exploration potential V_fed(x₁, . . . , x_N)=Σ_i V_explore\hat{ }{(i)}(x_i)+Σ{i<j} φ(D_cur\hat{ }{(i,j)}, D_metric\hat{ }{(i,j)}, D_found\hat{ }{(i,j)}), using divergence values derived from per-instance geometric data structures. A cross-agent recombiner 146c applies recombination operators R_{i,j}(T_i, T_j)=Blend_λ(T_i, T_j) by performing exponential-map-based combinations across structures exchanged by participating instances. A shared hypothesis generator 146d computes collective hypothesis trajectories \tilde{γ}_shared(t)=(1/N) Σ_i \tilde{γ}\hat{ }{(i)}(t) using coordinate-aligned averaging and annealing procedures executed on the product manifold. A dream alignment operator 146e computes alignment mappings A_{i,j} by minimizing metric-difference functionals across dreamspace geometries encoded in coordinate charts. A federated flow coordinator 146f manages joint stochastic evolution on the product manifold by applying manifold-adapted SDE integration of flows of the form dX(t)=−∇V_fed(X(t)) dt+Σ_fed(X(t)) dW_t, where Σ_fed correlates noise across instances using block-structured covariance representations. A sync manager 146g coordinates timing and synchronization of federated dreaming operations across participating instances using distributed signaling or clock-alignment protocols. Outputs from the federated dreaming coordinator 146 include cross-instance recombined structures and shared hypothesis trajectories, which flow to per-instance projection interfaces for independent admissibility evaluation.

An external interaction interface 101 provides the entry and exit point for exchanges between the interface and coordination layer 140 and external elements 199, including online cognitive manifolds M_cur, M₁, M₂, and M₃, persistent memory systems, and peer cognitive system instances participating in federated dreaming. During offline epochs, the offline isolation controller 144 enforces invariance of online cognitive manifolds by preventing modifications to memory manifold M_cur, cognitive surface M₁, mesoscale manifold M₂, and foundational manifold M₃. Upon system transition to online operation at t_on, the epoch boundary manager 144c signals release of projected candidate structures \hat{T} through the external interaction interface 101 for downstream evaluation by memory-management or metacognitive systems external to the dreaming and offline adaptation engine 100. The dream-output evaluation and projection interface 142 does not modify persistent memory directly; it prepares projected candidates for optional acceptance by downstream systems only after the offline epoch concludes.

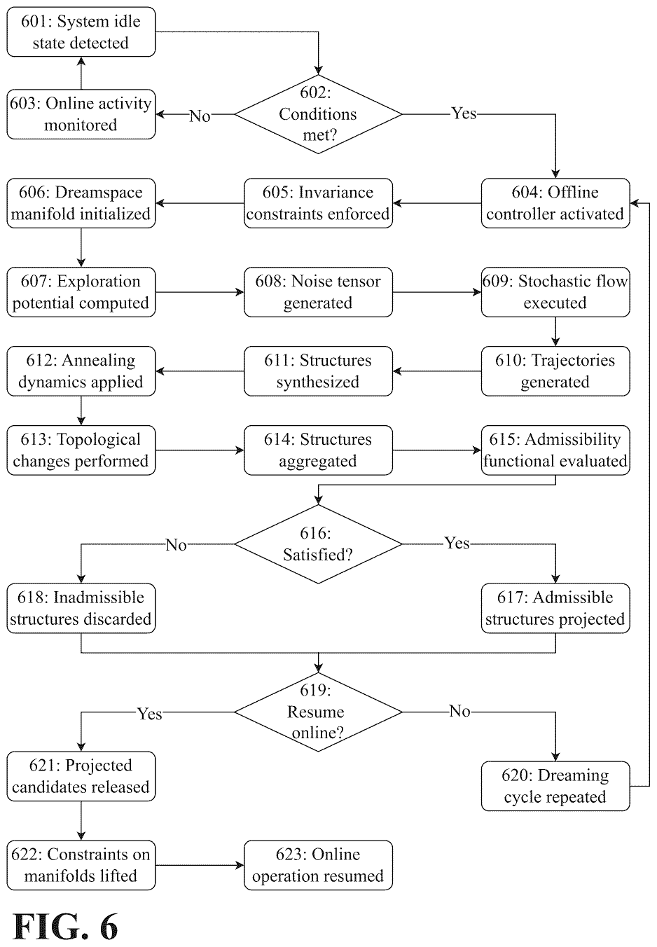

FIG. 6 is a flow diagram illustrating an exemplary offline dreaming cycle of a dreaming and offline adaptation engine 100, in an embodiment. The diagram traces a complete cycle beginning with detection of system idleness and proceeding through geometric initialization, stochastic exploration, generative synthesis, candidate evaluation, and re-entry to online operation.

The cycle begins at step 601, where the dreaming and offline adaptation engine 100 monitors system activity to detect cessation of online cognitive processes. At step 602, the offline isolation controller 144 evaluates system state to determine whether conditions for initiating an offline epoch have been satisfied. If conditions are not met, the engine resumes monitoring at step 603 and returns to step 601. If conditions are satisfied, the offline isolation controller 144 is activated at step 604.

At step 605, the offline isolation controller 144 enforces invariance constraints on online cognitive manifolds, including M_cur, M₁, M₂, and M₃, by restricting access to these structures and preventing memory updates throughout the offline interval.

The dreamspace foundation layer 110 then initializes the geometric substrate for offline operation. At step 606, the dreamspace manifold constructor 112 generates the dreamspace manifold 102 by computing a metric tensor g_dream, establishing a tangent bundle, and generating local coordinate charts. At step 607, the exploration potential generator 114 receives visitation density data ρ(x) via the external interaction interface 101 and computes the scalar potential field V_explore(x)=−log(ρ(x)+ε), emphasizing underrepresented regions of experiential space. At step 608, the dream noise tensor operator 116 computes a noise tensor Σ_dream(x): [symbol] \hat{ }k→T_xM_dream, incorporating local curvature information and optional resonance signatures to guide stochastic perturbation.

The generative dynamics layer 120 executes stochastic manifold evolution. At step 609, the stochastic dreaming flow engine 122 integrates stochastic differential equations of the form dX(t)=f_dream(X(t)) dt+Σ_dream(X(t)) dW_t using manifold-adapted solvers, where f_dream(x)=−∇V_explore(x)+ξ(x) includes structured exploratory perturbations. At step 610, the counterfactual trajectory generator 124 constructs counterfactual trajectories \tilde{γ}(t) through perturbed geodesic shooting and drift inversion, enabling departure from stored cognitive or experiential trajectories.

At step 611, the synthesis and perturbation layer 130 applies generative transformations to geometric entities within the dreamspace. The recombination and generative synthesis engine 132 performs geometric blending, extrapolative interpolation, and trajectory recombination to create novel structures T_new. At step 612, the annealing and cooling dynamics engine 134 evolves candidate structures through annealing flows of the form dT/dt=−∇V_dream(T)+σ(t) η(t), where σ(t) decreases over time to encourage convergence to refined attractor configurations. At step 613, the topological and structural perturbation engine 136 performs modifications to manifold topology through operations such as handle attachment, hole evolution, branching, and sheet duplication, expanding the geometric expressivity of the dreamspace manifold 102.

The interface and coordination layer 140 then evaluates dream-generated structures. At step 614, the candidate generator 142a aggregates outputs from upstream subsystems into a candidate set T_cand. At step 615, the admissibility evaluator 142b computes an admissibility functional A_adm(T)=λ₁ Φ_geom(T)+λ₂ Φ_curv(T)+λ₃ Φ_reg(T) to assess each structure's coherence, curvature compliance, and regularity. At step 616, the threshold comparator 142g filters candidates based on the condition A_adm(T)<τ. At step 617, the projection operator 142f maps admissible structures into a projected candidate set \hat{T} via minimization procedures that preserve geometric compatibility with the memory manifold M_cur. At step 618, candidate structures failing the admissibility threshold are excluded from projection and not forwarded for evaluation.

At step 619, the epoch boundary manager 144c determines whether online operation is resuming. If not, the dreaming and offline adaptation engine 100 returns to step 609 for additional stochastic evolution. If online activity is resuming, the process continues to step 620, where final evaluations are conducted.

At step 621, the dream-output evaluation and projection interface 142 transmits projected candidates \hat{T} to a transient buffer via the external interaction interface 101. At step 622, the offline isolation controller 144 lifts invariance constraints on M_cur, M₁, M₂, and M₃, restoring access to online cognitive structures. At step 623, the system transitions from offline to online operation, making the projected candidate structures \hat{T} available for downstream evaluation by memory management or metacognitive subsystems external to the dreaming and offline adaptation engine 100.

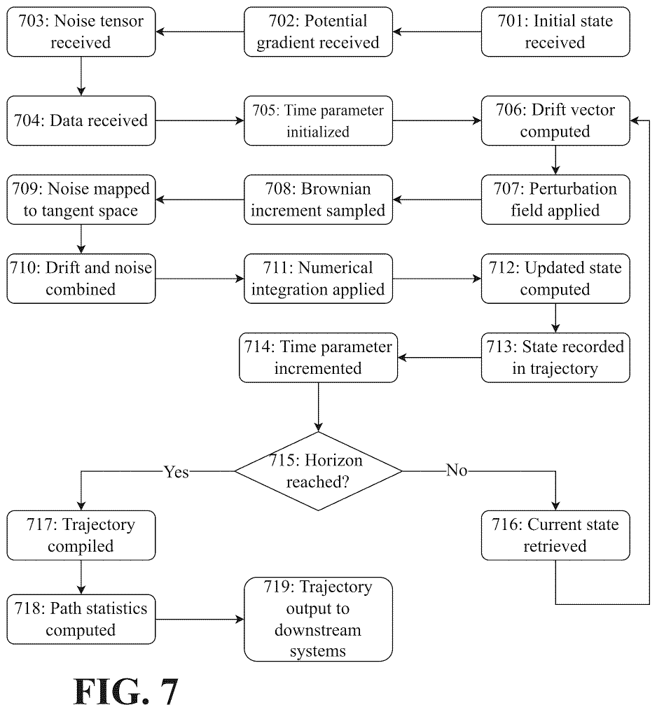

FIG. 7 is a flow diagram illustrating stochastic manifold evolution within a dreamspace manifold 102 of a dreaming and offline adaptation engine 100, in an embodiment. The flow diagram illustrates evolution of state trajectories according to drift and noise components and the generation of evolved representations by a stochastic dreaming flow engine 122.

At step 701, the stochastic dreaming flow engine 122 receives an initial state X₀ located on the dreamspace manifold 102, which may correspond to a lifted or previously evolved experiential structure. At step 702, the engine receives an exploration potential V_explore and its gradient ∇V_explore from the exploration potential generator 114. At step 703, the engine receives a state-dependent noise tensor Σ_dream from the dream noise tensor operator 116. At step 704, the engine receives the metric tensor g_dream and associated coordinate chart specifications from the dreamspace manifold constructor 112. At step 705, a time parameter t is initialized to zero to begin temporal integration.

At step 706, the drift field processor 122b computes the drift vector field f_dream by applying gradient descent to the exploration potential, using the relation f_dream(x)=−∇V_explore(x). At step 707, a structured perturbation field ξ(x) is added to f_dream to introduce deviation from strictly potential-driven flows, enabling broader exploratory dynamics. At step 708, the noise sampler 122c samples a Brownian motion increment dW_t. At step 709, the sampled increment is mapped through the noise tensor Σ_dream to produce a tangent-space vector in TₓM_dream, introducing anisotropic stochastic variation aligned with local curvature.

At step 710, the SDE integrator 122a constructs an update expression combining the drift component f_dream dt and the mapped stochastic increment Σ_dream dW_t. At step 711, a manifold-adapted numerical integration step is applied to advance the system state on the manifold, respecting coordinate constraints and geometric consistency. At step 712, the updated state X(t+dt) is computed. At step 713, the trajectory accumulator 122d stores the updated state in a discrete trajectory buffer representing X(t) over time. At step 714, the time parameter t is incremented by dt to continue temporal evolution.

At step 715, the system evaluates whether the predefined time horizon T has been reached. If not, the current state is retrieved for the next integration step at step 716, and the process returns to step 706. If the time horizon has been reached, the trajectory accumulator 122d compiles the complete trajectory X(t) over the interval [0, T] at step 717. At step 718, the accumulator computes statistical properties of the trajectory, such as cumulative displacement, geodesic deviation, or exploration entropy, for use in downstream evaluation.

At step 719, the evolved trajectory X(t) is transmitted to downstream subsystems including the counterfactual trajectory generator 124 and the synthesis and perturbation layer 130 for further processing, recombination, or refinement.

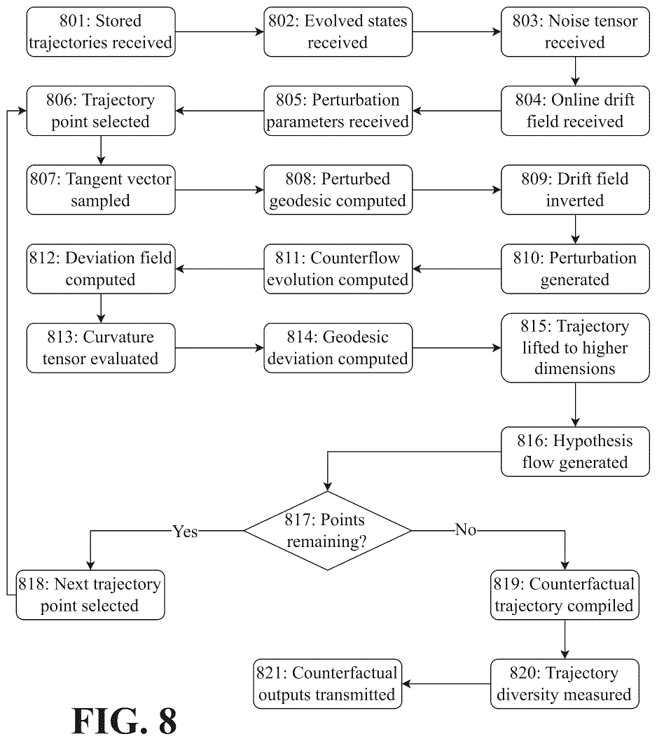

FIG. 8 is a flow diagram illustrating counterfactual trajectory generation within a dreaming and offline adaptation engine 100, in an embodiment. The flow diagram illustrates perturbed geodesic shooting and drift inversion mechanisms for producing trajectories that deviate from stored experiential paths.

At step 801, the counterfactual trajectory generator 124 receives stored experiential or cognitive trajectories γ(t) from experiential or memory manifolds via the external interaction interface 101. At step 802, the generator receives evolved state trajectories X(t) from the stochastic dreaming flow engine 122. At step 803, the generator receives the noise tensor Σ_dream and associated tangent-field sampling distributions from the dream noise tensor operator 116. At step 804, the generator receives the online drift field f_real, which governs cognitive state evolution during online operation. At step 805, perturbation parameters ε are received, specifying the magnitude of geodesic deviation for counterfactual shooting.

At step 806, the geodesic perturber 124a selects a reference point γ(t) along a stored trajectory. At step 807, a tangent vector v(t) is sampled from a distribution shaped by the local noise tensor Σ_dream at γ(t). At step 808, a perturbed trajectory \tilde{γ}(t) is computed by applying the exponential map to ε-scaled v(t), producing \tilde{γ}(t)=exp_{γ(t)}(ε v(t)), which defines a geodesic offset into unexplored regions of the dreamspace manifold 102.

At step 809, the drift inverter 124b computes an inverted drift vector by evaluating −f_real(γ(t)), generating a counterflow direction opposing the stored trajectory. At step 810, a bounded perturbation δ(t) is generated to introduce structured deviation into the inverted flow. At step 811, a counterflow evolution \dot{\tilde{γ}}(t) is computed using the relation \dot{\tilde{γ}}(t)=−f_real(γ(t))+δ(t), defining a secondary counterfactual path derived from inversion of cognitive dynamics.

At step 812, the deviation field calculator 124c computes a deviation vector field J(t) representing the difference between the perturbed trajectory \tilde{γ}(t) and the original trajectory γ(t). At step 813, the local curvature tensor R_dream of the dreamspace manifold is evaluated at \tilde{γ}(t). At step 814, geodesic deviation is computed using the curvature tensor and noise perturbations according to the relation D²J/dt²=R_dream(\dot{\tilde{γ}}, J)\dot{\tilde{γ}}+Ξ(t), where Ξ(t) denotes curvature-dependent stochastic effects.

At step 815, the trajectory lifter 124e embeds the perturbed trajectory into a higher-dimensional coordinate representation of the dreamspace manifold by appending latent exploratory variables, enabling movement along generative axes not present in the experiential manifold. At step 816, the hypothesis flow generator 124d computes additional counterfactual paths by applying gradient flows to latent hypothesis potentials, yielding structured alternatives grounded in dreamspace semantics.

At step 817, the counterfactual trajectory generator 124 evaluates whether additional points remain along the stored trajectory γ(t). If so, the process advances to the next trajectory point at step 818 and returns to step 806. If no further points remain, the generator compiles the completed counterfactual trajectory \tilde{γ}(t) at step 819.

At step 820, trajectory diversity metrics D(\tilde{γ}) are computed to quantify the extent of deviation from the original cognitive flow, using functional evaluations such as D(\tilde{γ})=∫₀^{T}∥\dot{\tilde{γ}}(t)−f_real(γ(t))∥² dt. At step 821, the counterfactual trajectory generator 124 outputs the computed counterfactual trajectories and associated deviation fields to downstream subsystems, including the dreaming energy functional evaluator 126 and the synthesis and perturbation layer 130, for further refinement or recombination.

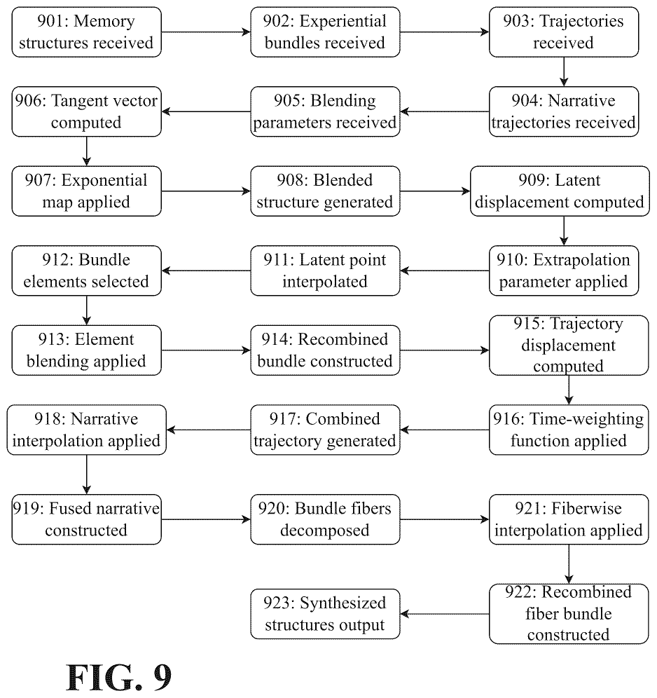

FIG. 9 is a flow diagram illustrating recombination and generative synthesis operations within a dreaming and offline adaptation engine 100, in an embodiment. The flow diagram illustrates geometric blending, latent-manifold interpolation, bundle recombination, trajectory recombination, narrative fusion, and fiber-bundle recombination processes performed by a recombination and generative synthesis engine 132.

At step 901, the recombination and generative synthesis engine 132 receives memory structures T₁ and T₂ from the dreamspace manifold 102. At step 902, the engine receives experiential bundles B₁ and B₂ via the external interaction interface 101. At step 903, the engine receives trajectories γ₁ and γ₂, which may include real trajectories from experiential manifolds and counterfactual trajectories generated by the counterfactual trajectory generator 124. At step 904, narrative trajectories ν₁ and ν₂ are received through the external interaction interface 101. At step 905, the engine receives interpolation and blending parameters λ, α, and θ, which respectively govern interpolation strength, extrapolation magnitude, and time-varying weighting.

At step 906, the geometric blender 132a computes a tangent vector between T₁ and T₂ by evaluating the logarithmic map log_{T₁}(T₂) on the dreamspace manifold. At step 907, the blender applies the exponential map at T₁ to the scaled tangent vector λ·log_{T₁}(T₂), producing an intermediate blended structure. At step 908, the resulting structure T_new is formed as a geometric interpolation between T₁ and T₂ along the connecting geodesic.

At step 909, the latent interpolator 132b computes a displacement vector between latent points x and y using the logarithmic map log_{x}(y). At step 910, an extrapolation parameter a is applied to extend the interpolation beyond the unit interval. At step 911, the exponential map exp_{x}(α·log_{x}(y)) is evaluated to generate the interpolated latent point, enabling synthesis of structures outside the convex hull of prior data.

At step 912, the bundle recombiner 132e selects element pairs (x₁, x₂) from B₁ and B₂ for recombination. At step 913, pairwise blending operations are applied to these elements using the interpolation parameter λ. At step 914, the recombined bundle B_new is constructed as a set of blended elements representing a hybridization of B₁ and B₂.

At step 915, the trajectory combiner 132c computes a displacement between γ₁(t) and γ₂(t) by evaluating the logarithmic difference at corresponding time points. At step 916, a smooth weighting function θ(t) is applied to modulate the contribution of each trajectory over time. At step 917, the exponential map is used to reconstruct a hybrid trajectory γ_comb(t) from the time-dependent interpolated vectors.

At step 918, the narrative fuser 132d applies a position-dependent interpolation function α(s) to the narrative trajectories ν₁(s) and ν₂(s), where s parameterizes narrative progression. At step 919, the fuser generates a fused narrative ν_fuse(s) that represents a blended narrative construct derived from the input trajectories.

At step 920, the fiber interpolator 132f decomposes experiential bundles into sensory (E), conceptual (C), and narrative (N) fiber components. At step 921, geometric interpolation is applied across corresponding fiber components using a weighting parameter θ. At step 922, the interpolated components are reassembled into a composite fiber bundle S_θ(B₁, B₂) representing a recombined experiential structure with integrated semantic content.

At step 923, the recombination and generative synthesis engine 132 outputs the synthesized structures—including blended memory structures T_new, interpolated latent points, recombined bundles B_new, combined trajectories γ_comb, fused narratives ν_fuse, and recombined fiber bundles—to downstream subsystems, including the annealing and cooling dynamics engine 134, for further refinement and evaluation.

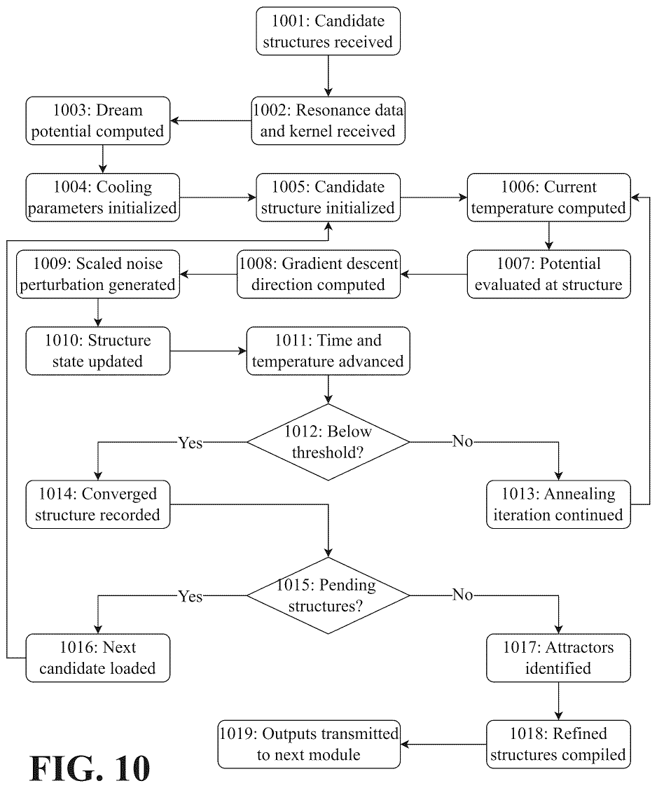

FIG. 10 is a flow diagram illustrating annealing and cooling dynamics within a dreaming and offline adaptation engine 100, in an embodiment. The flow diagram illustrates the evolution of candidate structures under stochastic perturbation with decreasing noise amplitude and the emergence of attractor configurations through temperature-driven convergence.

At step 1001, the annealing and cooling dynamics engine 134 receives candidate structures generated by the recombination and generative synthesis engine 132. At step 1002, resonance signatures σ_exp and a similarity kernel K are received through the external interaction interface 101. At step 1003, the dream potential evaluator 134a computes the dream potential V_dream(x) by integrating the similarity kernel against the resonance field across the experiential manifold, using the relation, for example:

$$V\_dream ( x ) = \int \_ \{ M\_exp \} K ( x , y ) \cdot σ\_exp ( y ) d μ ( y ) ,$$

where μ denotes the measure over M_exp.

At step 1004, the cooling schedule controller 134b initializes the annealing schedule by setting the initial temperature σ₀ and cooling rate α. At step 1005, the stochastic refiner 134c selects a candidate structure T and initializes it at a starting position on the dreamspace manifold 102.

At step 1006, the cooling schedule controller 134b computes the current temperature σ(t) according to an exponential decay function, σ(t)=σ₀·e\hat{ }(−αt). At step 1007, the dream potential V_dream(T) is evaluated at the current position of the structure. At step 1008, the stochastic refiner 134c computes the gradient −∇V_dream(T), which directs the structure toward regions of lower potential. At step 1009, a stochastic perturbation η(t) is generated, scaled by the current temperature σ(t), to introduce controlled exploratory variation. At step 1010, the structure is updated using the annealing flow equation in an embodiment:

$$dT / dt = - ∇ V\_dream ( T ) + σ ( t ) \cdot η ( t )$$

which combines deterministic descent with temperature-scaled stochasticity.

At step 1011, the cooling schedule controller 134b advances the time parameter and updates the temperature for the next iteration. At step 1012, the convergence monitor 134e checks whether the current temperature σ(t) has fallen below a predefined convergence threshold. If the temperature remains above threshold, annealing continues at step 1013, and the process returns to step 1006. If convergence is detected, the attractor identifier 134d records the final structure as a converged state at a low-potential basin of the dreamspace manifold at step 1014.

At step 1015, the engine determines whether additional candidate structures remain in the processing queue. If additional candidates are pending, the stochastic refiner 134c loads the next structure at step 1016 and returns to step 1005. If no candidates remain, the attractor identifier 134d aggregates the set of final structures into attractor configurations A_dream at step 1017, representing emergent abstractions or generalized experiential templates.

At step 1018, the annealing and cooling dynamics engine 134 compiles the set of refined structures and their corresponding attractors. At step 1019, these outputs are transmitted to the topological and structural perturbation engine 136 for further modification, recombination, or evaluation.

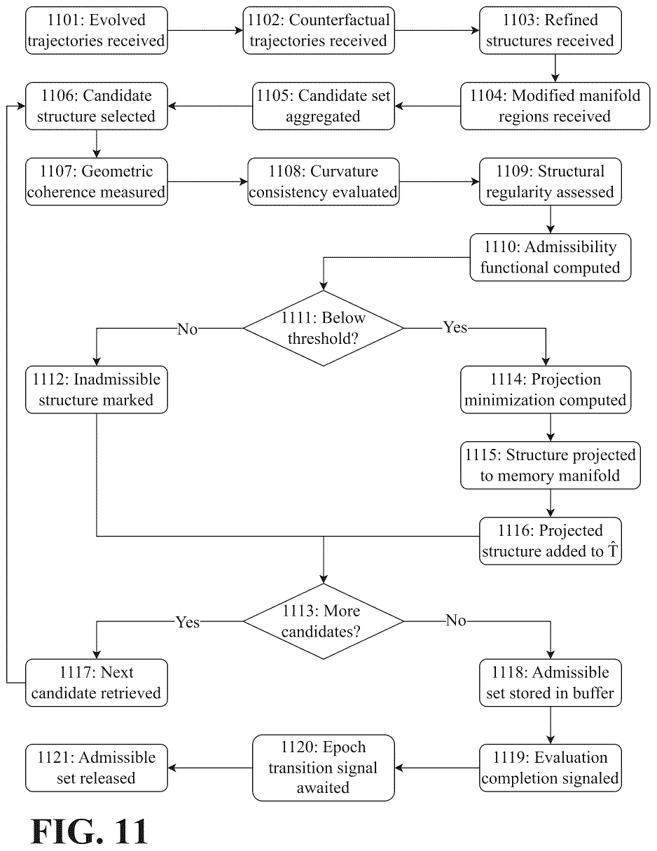

FIG. 11 is a flow diagram illustrating output evaluation and projection within a dreaming and offline adaptation engine 100, in an embodiment. The flow diagram illustrates candidate generation, admissibility evaluation, projection to the memory manifold, and release to a transient buffer upon completion of an offline epoch.

At step 1101, the dream-output evaluation and projection interface 142 receives evolved state trajectories X(t) from the stochastic dreaming flow engine 122. At step 1102, counterfactual trajectories \tilde{γ}(t) are received from the counterfactual trajectory generator 124. At step 1103, refined structures and attractor configurations are received from the annealing and cooling dynamics engine 134. At step 1104, modified manifold regions are received from the topological and structural perturbation engine 136. At step 1105, the candidate generator 142a aggregates all received outputs into a unified candidate set T_cand comprising diverse dreamspace entities for evaluation.

At step 1106, the admissibility evaluator 142b selects a candidate structure T∈T_cand for evaluation. At step 1107, the geometric coherence analyzer 142c computes Φ_geom(T), a measure of alignment between the candidate structure and the memory manifold M_cur based on geometric consistency. At step 1108, the curvature consistency checker 142d evaluates Φ_curv(T), assessing whether the structure's curvature profile falls within defined bounds. At step 1109, the regularity assessor 142e computes Φ_reg (T), quantifying continuity and representational completeness.

At step 1110, the admissibility functional A_adm(T) is computed as a weighted sum of the individual criteria:

$$A\_adm ( T ) = {λ}_{1} Φ\_geom ( T ) + {λ}_{2} Φ\_curv ( T ) + {λ}_{3} Φ\_reg ( T )$$

where λ₁, λ₂, and λ₃ are tunable weighting parameters. At step 1111, the threshold comparator 142g determines whether A_adm(T)<τ, where τ defines the admissibility threshold.

If the candidate structure fails the admissibility condition, it is marked as inadmissible at step 1112 and excluded from projection. At step 1113, the system checks whether additional candidates remain in T_cand. If candidates remain, the evaluator proceeds to step 1117 and returns to step 1106 for the next structure.

If the admissibility threshold is satisfied, the projection operator 142f computes a projection mapping using minimization over both geometric distance and curvature deviation. At step 1115, the structure is projected from the dreamspace manifold 102 to the memory manifold M_cur using the operator Π_cur, defined by, for example:

$$\prod \_cur ( x ) = argmin\_ \{ y ∈ M\_cur \} [ d\_ \{ g\_dream \} {( x , y )}^{2} + β \vert Curv\_dream ( x ) - Curv\_cur ( y ) \vert ] .$$

At step 1116, the projected structure is added to the admissible candidate set \hat{T}.

Once all candidate structures have been evaluated (step 1113), the admissible set \hat{T} is stored in a transient buffer at step 1118. At step 1119, the dream-output evaluation and projection interface 142 signals the offline isolation controller 144 that output evaluation is complete. At step 1120, the system awaits receipt of the epoch transition signal t_on from the epoch boundary manager 144c. Upon receiving the signal, the interface releases the admissible candidate set \hat{T} through the external interaction interface 101 at step 1121, making it available for downstream evaluation during online operation.

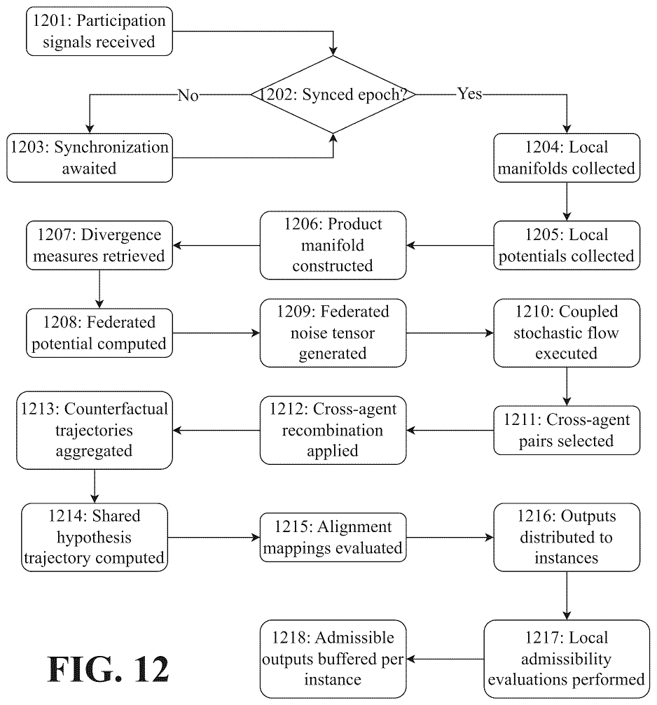

FIG. 12 is a flow diagram illustrating federated dreaming coordination across multiple cognitive system instances within a dreaming and offline adaptation engine 100, in an embodiment. The flow diagram illustrates product manifold construction, coupled stochastic exploration, cross-agent recombination, and per-instance projection and buffering for systems participating in a federated cognitive fabric.

At step 1201, the sync manager 146g of the federated dreaming coordinator 146 receives participation signals from instance coordinators of all active persistent cognitive machine instances. At step 1202, the sync manager 146g determines whether all participating instances have entered a synchronized offline epoch. If synchronization has not been achieved, the sync manager waits for additional signals at step 1203 and then returns to step 1202. Once synchronization is confirmed, the federated dreaming coordinator 146 proceeds to collect the local dreamspace manifold from each instance at step 1204. At step 1205, the coordinator retrieves each instance's local exploration potential.

At step 1206, the product dreamspace constructor 146a forms a product dreamspace manifold by composing the local dreamspace manifolds from all participating instances using compatible coordinate structures. At step 1207, the federated dreaming coordinator 146 retrieves divergence measures across instances—including memory divergence, metric divergence, and foundational divergence—via the external interaction interface 101. At step 1208, the federated potential generator 146b computes a federated exploration potential V_fed, incorporating both the local exploration potentials and cross-instance coupling terms derived from the divergence metrics.

At step 1209, the federated flow coordinator 146f constructs a federated noise tensor that encodes cross-instance stochastic correlation, enabling synchronized perturbations across agents. At step 1210, the coordinator executes a coupled stochastic flow on the product dreamspace manifold, combining drift derived from ∇V_fed and noise contributions from the correlated tensor to evolve collective states.

At step 1211, the cross-agent recombiner 146c selects pairs of structures originating from different instances for recombination. At step 1212, geometric blending operations are applied to generate cross-agent composite structures, enabling the synthesis of counterfactual constructs not present in any single instance. At step 1213, the federated dreaming coordinator 146 aggregates individual counterfactual trajectories generated by each agent during the coupled flow process.

At step 1214, the shared hypothesis generator 146d computes a shared hypothesis trajectory by averaging individual counterfactuals using logarithmic map composition on the product manifold. At step 1215, the dream alignment operator 146e computes alignment mappings between pairs of instances, evaluating similarity or divergence in exploratory tendencies based on metric deformation or semantic spread.

At step 1216, the federated dreaming coordinator 146 distributes the recombined structures and shared hypotheses to their originating instances. At step 1217, each participating instance performs local admissibility evaluation on received structures using its internal dream-output evaluation and projection interface 142, applying the same A_adm-based filtering process used for native structures. At step 1218, each instance projects admissible outputs to its local memory manifold and stores the resulting structures in a local transient candidate buffer for later evaluation upon return to online operation.

### Exemplary Computing Environment

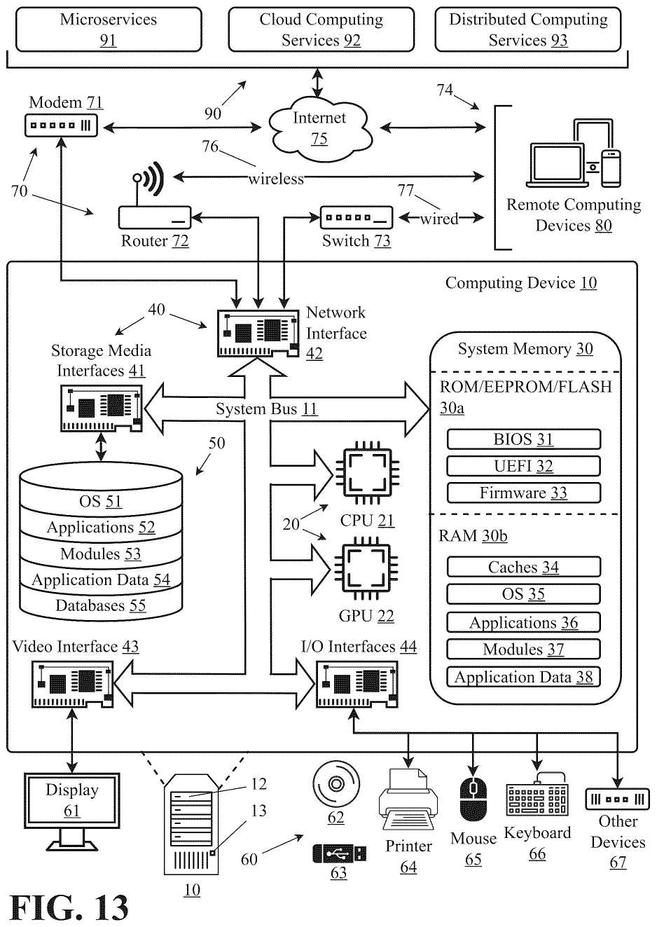

FIG. 13 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising one or more processors and a hardware memory storing instructions that, when executed by the one or more processors, cause the system to:
implement a dreamspace manifold configured to represent cognitive or experiential structures as geometric entities in a multi-dimensional space, the dreamspace manifold being distinct from online cognitive manifolds and comprising a metric defining geometric relationships within the dreamspace manifold;
implement an offline adaptation engine operatively coupled to the dreamspace manifold and configured to operate exclusively during offline periods to:
evolve states within the dreamspace manifold according to stochastic manifold-evolution processes comprising at least a drift component and a noise component;
generate counterfactual trajectories on the dreamspace manifold that deviate from stored experiential or cognitive trajectories; and
synthesize candidate geometric structures through one or more recombination or generative operations acting on entities within the dreamspace manifold;
implement a projection interface configured to:
evaluate candidate structures generated by the offline adaptation engine for geometric admissibility; and
project admissible structures from the dreamspace manifold into a candidate set for evaluation upon return to online operation, without directly modifying persistent memory; and
implement an isolation controller configured to prevent modification of online cognitive manifolds during operation of the offline adaptation engine.

2. The system of claim 1, wherein the drift component of the stochastic manifold-evolution processes is derived from an exploration potential that increases dynamical weight on regions of the dreamspace manifold having lower visitation density during online cognitive operation.

3. The system of claim 1, wherein the noise component comprises a noise tensor that is state-dependent and incorporates local curvature information derived from the metric of the dreamspace manifold.

4. The system of claim 1, wherein generating counterfactual trajectories comprises perturbing geodesic paths emanating from points along stored experiential or cognitive trajectories, inverting drift fields associated with online cognitive dynamics, or both.

5. The system of claim 1, wherein the one or more recombination or generative operations comprise geometric blending of manifold structures along geodesic paths connecting the structures within the dreamspace manifold.

6. The system of claim 1, wherein the offline adaptation engine is further configured to apply annealing dynamics to candidate structures, the annealing dynamics comprising stochastic perturbation with a noise amplitude that decreases over a dreaming interval according to a cooling schedule, thereby producing refined structures or emergent attractor configurations within the dreamspace manifold.

7. The system of claim 1, wherein the offline adaptation engine is further configured to apply topological perturbation operations to the dreamspace manifold, the topological perturbation operations being confined to offline operation and comprising controlled modifications to manifold topology that expand representational capacity of the dreamspace manifold.

8. The system of claim 1, wherein the offline adaptation engine is further configured to evolve the metric of the dreamspace manifold through curvature-inflation processes that increase local curvature in selected manifold regions, distinct from curvature-smoothing processes employed during online cognitive operation.

9. The system of claim 1, wherein the computer system is one of a plurality of cognitive system instances, and wherein the system is further configured to coordinate dreaming operations across the plurality of cognitive system instances through a federated dreaming process that couples stochastic exploration across respective dreamspace manifolds of the plurality of cognitive system instances and enables cross-instance synthesis of candidate structures.

10. A computer-implemented method comprising:
maintaining a dreamspace manifold configured to represent cognitive or experiential structures as geometric entities in a multi-dimensional space, the dreamspace manifold being distinct from online cognitive manifolds and comprising a metric defining geometric relationships within the dreamspace manifold;
during periods of offline operation, operating an offline adaptation engine operatively coupled to the dreamspace manifold to:
evolve states within the dreamspace manifold according to stochastic manifold-evolution processes comprising at least a drift component and a noise component;
generate counterfactual trajectories on the dreamspace manifold that deviate from stored experiential or cognitive trajectories; and
synthesize candidate geometric structures through one or more recombination or generative operations acting on entities within the dreamspace manifold;
evaluating candidate structures generated by the offline adaptation engine for geometric admissibility;
projecting admissible structures from the dreamspace manifold into a candidate set for evaluation upon return to online operation, without directly modifying persistent memory; and
preventing modification of online cognitive manifolds during operation of the offline adaptation engine.

11. The method of claim 10, wherein the drift component of the stochastic manifold-evolution processes is derived from an exploration potential that increases dynamical weight on regions of the dreamspace manifold having lower visitation density during online cognitive operation.

12. The method of claim 10, wherein the noise component comprises a noise tensor that is state-dependent and incorporates local curvature information derived from the metric of the dreamspace manifold.

13. The method of claim 10, wherein generating counterfactual trajectories comprises perturbing geodesic paths emanating from points along stored experiential or cognitive trajectories, inverting drift fields associated with online cognitive dynamics, or both.

14. The method of claim 10, wherein the one or more recombination or generative operations comprise geometric blending of manifold structures along geodesic paths connecting the structures within the dreamspace manifold.

15. The method of claim 10, further comprising applying annealing dynamics to candidate structures, the annealing dynamics comprising stochastic perturbation with a noise amplitude that decreases over a dreaming interval according to a cooling schedule, thereby producing refined structures or emergent attractor configurations within the dreamspace manifold.

16. The method of claim 10, further comprising applying topological perturbation operations to the dreamspace manifold during offline operation, the topological perturbation operations comprising controlled modifications to manifold topology that expand representational capacity of the dreamspace manifold.

17. The method of claim 10, further comprising evolving the metric of the dreamspace manifold through curvature-inflation processes that increase local curvature in selected manifold regions, distinct from curvature-smoothing processes employed during online cognitive operation.

18. The method of claim 10, wherein the method is performed by one of a plurality of cognitive system instances, and wherein the method further comprises coordinating dreaming operations across the plurality of cognitive system instances through a federated dreaming process that couples stochastic exploration across respective dreamspace manifolds of the plurality of cognitive system instances and enables cross-instance synthesis of candidate structures.
